(19) United States
(12) Patent Application Publication
(10) Pub. No.: US 2022/0227677 A1
(43) Pub. Date: Jul. 21, 2022

(54) CARBONATION SYSTEM FOR CURING OF CONCRETE PRODUCTS AT AMBIENT PRESSURE

(71) Applicants: Iman Mehdipour, Los Angeles, CA (US); Raghubir Gupta, Cary, NC (US); Gabriel D. Falzone, Los Angeles, CA (US); Gaurav N. Sant, Los Angeles, CA (US); Dante Simonetti, Los Angeles, CA (US)

(72) Inventors: Iman Mehdipour, Los Angeles, CA (US); Raghubir Gupta, Cary, NC (US); Gabriel D. Falzone, Los Angeles, CA (US); Gaurav N. Sant, Los Angeles, CA (US); Dante Simonetti, Los Angeles, CA (US)

(21) Appl. No.: 17/572,448

(22) Filed: Jan. 10, 2022

Related U.S. Application Data
(60) Provisional application No. 63/136,618, filed on Jan. 12, 2021.

(51) Int. Cl. C04B 40/02; B01J 19/14; B01J 19/00; B01J 19/26; B28B 11/24

(52) U.S. Cl. CPC C04B 40/0231; B01J 19/14; B01J 19/0013; B01J 19/26; C04B 14/06; B01J 2219/00029; B01J 2219/00155; B01J 2219/00166; B01J 2219/00243; B28B 11/245

(57) ABSTRACT

Provided herein are systems for carbonation curing and CO₂ mineralization of concrete composites and methods of manufacturing a carbonated concrete composite. A method of manufacturing a carbonated concrete composites includes contacting concrete with CO₂-containing gas streams in the carbonation reactor having a gas stream inlet and an outlet to provide optimal gas flow distribution and gas velocity. The concrete precursor includes a binder, one or more aggregates, and water. A gas stream is received at the carbonation reactor. The gas stream includes carbon dioxide. The concrete precursor is maintained at a suitable temperature in the carbonation reactor to thereby react the concrete precursor with the gas stream to produce carbonate minerals in the carbonated concrete composite.

### CROSS-REFERENCE TO RELATED APPLICATION

This application claims the benefit of U.S. Provisional Application No. 63/136,618, filed on Jan. 12, 2021, which is hereby incorporated by reference in its entirety.

### GOVERNMENT SUPPORT

This invention was made with government support under Grant Numbers DE-FE0029825, DE-FE0031718, and DE-FE0031915, awarded by the U.S. Department of Energy and Grant Number 1922167, awarded by the National Science Foundation. The government has certain rights in the invention.

### FIELD OF THE INVENTION

Embodiments of the present disclosure generally relate to carbon dioxide (CO₂) mineralization of concrete composites. More specifically, the present disclosure relates to a system for carbonation curing of concrete composites and methods of manufacturing a carbonated concrete composite. The binder of concrete includes at least one of the hydrated lime, cement and/or coal combustion residues (such as fly ash) that are combined with aggregates and water to make concrete mixtures. The concrete mixture is then contacted with flue gas containing CO₂ inside of the carbonation chamber.

### BACKGROUND

Concrete is generally made of one or more aggregates (e.g., sand, gravel, crushed stone, etc.) and a paste (e.g., water and a binder). In most concretes, the binder is ordinary portland cement. Manufacture of the binder (e.g., a cementation agent), however, involves processes that generate and release large amounts of carbon dioxide—a greenhouse gas—into the atmosphere. Calcination of carbonate rocks during the manufacture of cement produced 5% of global CO₂ emissions from all industrial process and fossil-fuel combustion in 2013. Greenhouse gases absorb solar energy and keep heat close to Earth's surface, rather than letting it escape into space. This trapping of heat is known as the greenhouse effect, which leads to global warming. Rising levels of carbon dioxide in the atmosphere have been associated with global warming.

Moreover, some binders (e.g., low-carbon) are available for use in the manufacture of concrete composites. However, concrete composites made with these binders generally have weaker material properties than concrete composite made with other binders, thus making the concrete composites made with certain binders unsuitable for most building purposes.

Accordingly, there exists a need for systems and processes for carbonation curing of concrete composites. Additionally, there exists a need for carbonation curing of concrete composites using industrial waste gas.

### SUMMARY OF THE INVENTION

In various embodiments, a method of manufacturing a carbonated concrete composite is provided where a concrete precursor is placed into a carbonation reactor for carbonation curing. The concrete precursor includes a binder, aggregates, and water. The carbonation reactor has at least one gas stream inlet and an outlet. A gas stream is received at the at least one inlet of the carbonation reactor. The gas stream includes carbon dioxide. A suitable temperature, relative humidity, CO₂ amount, gas stream flow rate, or a combination thereof is maintained in the carbonation reactor so a carbonation rate constant of the concrete precursor is at or above 0.005 to thereby react the concrete precursor with the gas stream and form the carbonated concrete composite.

In various embodiments, a CO₂ mineralization system includes a gas humidification chamber, a gas stream coupled to an input of the humidifier, and a gas inlet coupled to a carbonation reactor and an output of the humidification chamber. The gas stream comprises carbon dioxide. The carbonation reactor is configured to receive concrete and react the concrete with the gas stream to thereby form a carbonated concrete composite.

In various embodiments, a method of manufacturing a first carbonated concrete composite and a second carbonated concrete component is provided where a first concrete masonry unit (CMU) precursor is placed into a carbonation reactor for carbonation curing. The first CMU precursor includes a binder, aggregates, and water. The carbonation reactor has at least one gas stream inlet and an outlet. The first CMU precursor is exposed to a gas stream from the at least one gas stream inlet of the carbonation reactor. The gas stream includes carbon dioxide. A temperature, relative humidity, CO₂ amount, gas stream flow rate, or a combination thereof is maintained in the carbonation reactor so that a carbonation rate constant of the first CMU precursor is at or above 0.005 to thereby react the first CMU precursor with the gas stream and form the first carbonated concrete composite. The compressibility and/or porosity of the first carbonated concrete composite is measured. A second CMU precursor is placed into the carbonation reactor for carbonation curing. The second CMU precursor includes a binder, aggregates, and water. The second CMU precursor is exposed to a modified gas stream from the at least one inlet of the carbonation reactor. A temperature, relative humidity, CO₂ amount, gas stream flow rate, or a combination thereof is maintained in the carbonation reactor so that a carbonation rate constant of the second CMU precursor is at or above 0.005 to thereby react the second CMU precursor with the gas stream and form a second carbonated concrete composite.

### BRIEF DESCRIPTION OF THE SEVERAL VIEWS OF THE DRAWINGS

The patent of application file contains at least one drawing executed in color. Copies of this patent or patent application publication with color drawing(s) will be provided by the office upon request and payment of the necessary fee.

FIG. 1 illustrates a flow diagram of a CO₂ mineralization system used for carbonation of concrete composites in accordance with an embodiment of the present disclosure.

FIGS. 2A-2C illustrate inlet and outlet positions of the gas stream for longitudinal (FIG. 2A), transverse (FIG. 2B), and top flow (FIG. 2C) configurations of the carbonation reactor in accordance with an embodiment of the present disclosure.

FIG. 3A illustrates a computational fluid dynamics (CFD) simulation of gas flow distributions across the surfaces of a concrete block within the carbonation reactor for the top flow configuration in accordance with an embodiment of the present disclosure. FIG. 3B illustrates a contour plot of the gas velocity field across the surfaces of the concrete block in accordance with an embodiment of the present disclosure. FIG. 3C illustrates a finite element method (FEM) simulation of uniaxial compression of the carbonated block showing sections (i.e., sides, faces, and web) with different Young's moduli in accordance with an embodiment of the present disclosure.

FIGS. 4A-4B illustrate graphs of the time-dependent traces of the CO₂ uptake of the concrete block sections for different gas flow configurations for inlet and outlet positions in accordance with an embodiment of the present disclosure. FIG. 4C illustrates the evolution of the moisture ratio for different sections of the concrete block for varying gas flow configurations in accordance with an embodiment of the present disclosure.

FIG. 5A illustrates a CFD analysis of contacting gas velocity across different block surfaces for varying gas flow configurations in accordance with an embodiment of the present disclosure. FIG. 5B illustrates a graph of the evolution of the apparent carbonation rate constant as a function of contacting gas velocity in accordance with an embodiment of the present disclosure. FIG. 5C illustrates a graph of representative drying rate and carbonation rate at different contacting velocities in accordance with an embodiment of the present disclosure.

FIG. 6A illustrates a surface plot of the 24-h CO₂ uptake of a concrete block under different relative humidity (RH) and flow rate (Q) of gas at T=35° C. in accordance with an embodiment of the present disclosure. FIG. 6B illustrates a graph of the variations of contacting gas velocity as a function of flow rate for different block surfaces in accordance with an embodiment of the present disclosure. FIG. 6C illustrates a graph of the variations in 24-h CO₂ uptake as a function of initial pore water saturation (S_{w}) after the drying step in accordance with an embodiment of the present disclosure. FIG. 6D illustrates Arrhenius plots of the activation energy of moisture diffusion (Eₐ) at different gas RH during drying in accordance with an embodiment of the present disclosure.

FIG. 7A illustrates a graph of the variations in porosity across different sections of carbonated blocks as a function of CO₂ uptake under different gas flow configurations in accordance with an embodiment of the present disclosure. FIG. 7B illustrates a graph of the normalized strength evolution as a function of the CO₂ uptake for different sections of concrete blocks in accordance with an embodiment of the present disclosure. FIG. 7C illustrates a graph of the FEM analysis of the uniaxial compressive stress-displacement response of carbonated concrete blocks in accordance with an embodiment of the present disclosure. FIG. 7D illustrates a graph of the compressive strength as a function of the CO₂ uptake for different gas flow configurations in accordance with an embodiment of the present disclosure.

FIG. 8A illustrates a graph of the variations in the 24-h CO₂ uptake of different sections of the concrete block under different gas flow configurations in accordance with an embodiment of the present disclosure. FIG. 8B illustrates a graph of the dependence of carbonation rate constant on drying rate constant in accordance with an embodiment of the present disclosure.

FIG. 9A illustrates a graph of the CFD analysis of velocity non-uniformity index across different surfaces of the concrete block for varying gas flow configurations in accordance with an embodiment of the present disclosure. FIG. 9B illustrates a graph of the variations of pore water saturation (S_{w}) across different concrete block sections as a function of contacting gas velocity in accordance with an embodiment of the present disclosure. FIG. 9C illustrates a graph of the effect of contacting gas velocity across surfaces of concrete block on 24-h CO₂ uptake in accordance with an embodiment of the present disclosure.

FIG. 10 illustrates a graph of a comparison between measured and predicted 24-h CO₂ uptake response in accordance with an embodiment of the present disclosure.

FIG. 11 illustrates a desirability surface response of gas processing conditions to satisfy defined performance targets in accordance with an embodiment of the present disclosure.

FIGS. 12A-12D illustrate graphs of FEM simulations of uniaxial compressive stress-displacement responses for different sections of: reference block (FIG. 12A), and for longitudinal flow (FIG. 12B), transverse flow (FIG. 12C), and top flow (FIG. 12D) configurations in accordance with an embodiment of the present disclosure.

### DETAILED DESCRIPTION

The present invention advantageously uses carbon dioxide gas (e.g., carbon dioxide from flue gases, carbon dioxide as high pressure cylinder gas, etc.) during curing processes to sequester CO₂ via carbonate mineral formation in concrete composites. In particular, the present invention uses CO₂ to carbonate concrete composites into carbonated concrete composites, thereby providing a method for manufacturing carbonated concrete composites in a way that results in a smaller embodied carbon intensity (eCI). In various embodiments, the concrete composites are made with low-carbon binders (e.g., industrial solid waste). The concrete composites manufactured using the methods described herein have similar material properties to commercially-available concrete composites, but reduce the greenhouse gas (e.g., carbon dioxide) emissions into the atmosphere during the manufacture of that utilizes waste CO₂ for the manufacture of the concrete composite itself. An exemplary embodiment of the systems and methods presented herein, as well as related supplemental information, is described in “The role of gas flow distributions on CO₂ mineralization within monolithic cemented composites: coupled CFD-factorial design approach.” React. Chem. Eng., 2021, 6, 494-504 (accessible online at https://doi.org/10.1039/D0RE00433B), which is hereby incorporated by reference herein in its entirety.

More particularly, disclosed herein are systems for CO₂ mineralization of concrete composites. Additionally, disclosed herein are methods of carbonation curing of concrete composites. In various embodiments, a method of manufacturing a carbonated concrete composite includes providing a concrete precursor to a carbonation curing reactor. The binder of concrete includes at least one of hydrated lime, cement, and/or coal combustion residues (e.g., fly ash) that are combined with aggregates, and water to make concrete mixtures. A gas stream of carbon dioxide gas is received at the carbonation reactor. The gas stream is flowed into the carbonation reactor while heating the carbonation reactor to thereby react the concrete precursor with the gas stream and form the carbonated concrete composite(s). In various embodiments, the resulting carbonated concrete composite has substantially similar engineering properties to a traditional concrete composite made with cement that hardens via hydration.

A carbonated concrete composite, as used herein, refers to a carbonated concrete object (e.g., a building material) made from early-age (e.g., fresh) concrete that is then contacted with a CO₂-containing curing gas having a suitable CO₂ concentration.

Material performance of a carbonated concrete composite is defined as porosity, compressibility, and/or or other mechanical or strength measurement (e.g., Young's modulus, yield strength, ultimate strength, fracture point, etc.).

Uniform material performance of a carbonated concrete component, as used herein, refers to substantially uniform material properties throughout the concrete component. That is, there are no significant gradients or variations in material performance from one area of the concrete composite to another area of the concrete composite.

A material performance gradient, as used herein, is a spatial difference in porosity and/or compressibility in the carbonated concrete composite. In various embodiments, for uniform material performance, the porosity, measured as a volume percent, and/or the compressibility does not vary by more than ±25% over a concrete volume unit of 1 m³. In various embodiments, for uniform material performance, the porosity and/or compressibility does not vary by more than +20% over a concrete volume unit of 1 m³. In various embodiments, for uniform material performance, the porosity and/or compressibility does not vary by more than +15% over a concrete volume unit of 1 m³. In various embodiments, for uniform material performance, the porosity and/or compressibility does not vary by more than ±10% over a concrete volume unit of 1 m³. In various embodiments, for uniform material performance, the porosity and/or compressibility does not vary by more than ±10% over a concrete volume unit of 10 cm³. In various embodiments, for uniform material performance, the porosity and/or compressibility does not vary by more than ±5% over a concrete volume unit of 10 cm³. In various embodiments, for uniform material performance, the porosity and/or compressibility does not vary by more than ±1% over a concrete volume unit of 10 cm³. For example, the compressibility may be measured according to ASTM C140 under uniaxial monotonic displacement-controlled loading using a hydraulic jack with a capacity of 800 kN. In this example, the carbonated concrete composite does not have a material performance gradient if the compressibility does not vary by more than ±10%, preferably +5% over a concrete volume unit of 10 cm³.

Formation of carbonate minerals via CO₂ mineralization (“mineral carbonation reactions”) offer a promising alternative to ordinary portland cement (OPC). CO₂ mineralization relies upon the reaction of dissolved CO₂ with inorganic alkaline reactants to precipitate mineral carbonate (e.g., CaCO₃), which binds proximate particles and results in cementation. In various embodiments, a shape-stabilized concrete green body (e.g., composed of a mixture of reactants, water, and mineral aggregates) is exposed to CO₂ (e.g., borne from industrial flue gas streams or concentrated CO₂). Such CO₂ mineralization and utilization may advantageously decarbonize cement production by creating a waste-to-value or carbon-to-value economy (e.g., by valorizing waste CO₂ borne in flue gases and alkaline solid wastes such as fly ashes), reducing the costs and liabilities associated with waste management, and promoting the principles of circular economy. In various embodiments, CO₂ mineralization allows the production of construction components that feature similar or equivalent engineering attributes to their OPC based counterparts while featuring a much smaller embodied carbon intensity (eCI). In various embodiments, the reduction in eCI of such carbonated concrete products is attributable to: (i) the utilization of CO₂ from a waste emissions stream during production and (ii) the avoidance of CO₂ emissions by the substitution of OPC with industrial solid wastes (e.g., fly ash) and/or alkaline solids. In various embodiments, portlandite (Ca(OH)₂) is used as an alkaline solid because it can be produced at a substantively lower temperature than OPC, while offering a high CO₂ uptake capacity for a non-porous inorganic reactant (e.g., about 59 mass %).

In various embodiments, the carbonation kinetics of alkaline solid reactants and concrete composites are affected by the gas processing conditions including: temperature (T), relative humidity (RH), CO₂ concentration [CO₂], and gas flow rate (Q). In various embodiments, for monoliths, the carbonation kinetics increase with decreasing RH and elevated T; so long as a minimum RH is exceeded. In various embodiments, reducing RH decreases the quantity of water within the pore spaces, which affects the so-called moisture saturation, S_{w}, thereby easing CO₂ transport into and within the microstructure. This is because, in a porous body, the gas diffusivity through the microstructure is inversely proportional to the microstructural resistance factor. In various embodiments, optimal carbonation conditions within batch reactors can be achieved with precise control of the gas processing conditions, flow rates, and flow distributions. In various embodiments, non-uniform gas flow and velocity can detrimentally impact moisture removal and drying and carbonation kinetics by imparting mass transfer resistance, leading to S_{w} gradients within monolithic components. In various embodiments, such S_{w} gradients result in non-uniform CO₂ uptake across the monolith volume and gradients in material properties (e.g., porosity).

In various embodiments, computational fluid dynamics (CFD) can be used for evaluating fluid flow patterns, and mixing processes to understand gas flow distributions and heat- and mass-transfer to inform the design of carbonation reactors. In various embodiments, gas velocity affects gas solid reactions. In various embodiments, developing reactor designs and process models for systems that promote the carbonation reactions of cementitious composites includes assigning non-uniform boundary conditions at the gas-solid interface and unsteady state (dynamic) processes. In various embodiments, gas flow distribution and processing conditions are varied during a CO₂ mineralization reaction for a representative monolith (herein a concrete masonry unit: CMUs, also known as concrete block) that is carbonated. In various embodiments, the reactor is a plug-flow style reactor. In various embodiments, the reactor is a batch reactor. In various embodiments, the reactor is operated at ambient pressure. In various embodiments, CFD simulations are used to link the velocity and spatial distributions of gas flowing across the monolith surfaces within a CO₂ mineralization reactor to drying front penetration and CO₂ diffusion and their effects on the measured bulk CO₂ uptake across monolith volume. In various embodiments, overall mechanical performance of a concrete composite (e.g., a building material) may be adjusted by way of stiffness/strength gradients resulting from the non-uniform carbonate-mineral formation. In various embodiments, these gradients may be analyzed via a finite element method (FEM). In various embodiments, for the optimal gas flow configuration, gas processing conditions (RH, T, and Q) may be adjusted to optimally facilitate gas diffusion within microstructure and enhance bulk CO₂ uptake across the monolith's volume. Taken together, optimized CO₂ mineralization reactors can be designed and optimal gas processing routes can be identified to enable the scalable production of low-eCI concrete composites using, for example, waste-CO₂ borne flue gas streams.

In various embodiments, a mixture of inorganic reactants (e.g., the binder), inert fine aggregates (e.g., sand), and water is mixed into dry-cast formulations suitable for the fabrication of concrete blocks, which is the monolith geometry considered herein. In various embodiments, the reactants used include hydrated lime (e.g., portlandite, Ca(OH)₂ powder, ASTM C150-compliant ordinary portland cement (Type I/II OPC), and ASTM C618-compliant fly ash). In various embodiments, the Ca(OH)₂ has a purity of 94% 2% (by mass) with the remainder being composed of CaCO₃ as determined by thermogravimetric analysis (TGA).

In various embodiments, a concrete composite-making machine is used to fabricate structural load bearing concrete composites (e.g., blocks). In various embodiments, such as when the composite is a block, the width of the composite is about 25 mm to about 1000 mm. In various embodiments, the length of the composite is from about 25 mm to about 1000 mm. In various embodiments, the height of the composite is from about 25 mm to about 500 mm. In various embodiments, the face-shell thickness of the composite is from about 5 mm to about 100 mm. In various embodiments, the web thickness of the composite is from about 5 mm to about 100 mm. For example, the blocks may include dimensions of 200 mm×200 mm×400 mm (w×h×L) with face-shell and web thicknesses of 32 mm and 25 mm, respectively yielding a surface-to-volume ratio of 0.081 mm⁻¹. In various embodiments, the % mass of binder is about 5% to about 50%. In various embodiments, the % mass of water is about 2% to about 20%. In various embodiments, the % mass of aggregates is about 50% to about 90%. In various embodiments, the concrete block mixture is formulated with 10 mass % dry binder, 4.5 mass % water with the remainder consisting of mineral aggregates. In various embodiments, after forming the concrete composites, the fresh concrete composites are pre-cured. For example, the fresh concrete composites are cured at T=21±1° C. for 12 hours to gain green strength (compressive strength σ_{c}=1.5±0.5 MPa) and enable handling and loading into the carbonation reactor with minimal (e.g., no) deformation from the intended shape. In various embodiments, after forming the concrete composite (e.g., block), the concrete composite is directly loaded into carbonation chamber to initiate carbonation curing without any pre-curing. Pre-curing, herein, refers to allowing at least some hydration of the cement-fraction of the concrete composite before carbonation curing. In various embodiments, based on the water content and the forming method, the pore water saturation S_{w}, of the concrete blocks prior to carbonation was on the order of 0.62±0.02 (unitless) determined as per ASTM C140.

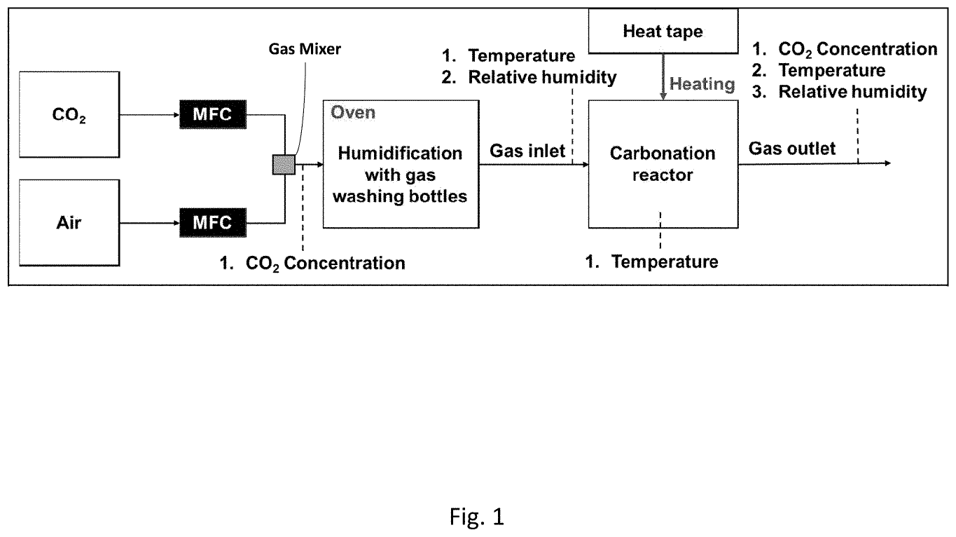

FIG. 1 illustrates a flow diagram of a CO₂ mineralization system used for carbonation of concrete composites. As shown in FIG. 1, a CO₂ mineralization system was fabricated consisting of gas mixing equipment, a humidification chamber, and a carbonation reactor. In various embodiments, gas processing parameters may be varied over a range of temperatures (e.g., 20° C.≤T≤80° C.), relative humidities (10%≤RH≤60%), and gas flow rates (0.10 slpm≤Q≤4.92 slpm). In various embodiments, the CO₂ concentration [CO₂] of the gas stream is about 4% to about 99%. In various embodiments, the CO₂ concentration simulates a CO₂-dilute flue gas stream of a coal-fired power plant. In some embodiments, the CO₂ gas source is an effluent from an industrial source (e.g., flue gas emitted from a natural gas-fired power plant, a coal-fired power plant, an iron mill, a steel mill, a cement plant, an ethanol plant, a chemical manufacturing plant, etc.). In some embodiments, the CO₂ source is a commercial product such as a commercially-available CO₂. In some embodiments, the CO₂ source is liquefied CO₂. In various embodiments, the gas mixture is prepared by mixing air and one or more CO₂ streams at prescribed flow rates using calibrated mass flow controllers (MFC). In various embodiments, the mixed gas stream is humidified. For example, the mixed gas stream is humidified by bubbling the mixed gas stream through gas washing bottles placed in an oven. In various embodiments, the humidified gas stream is passed into the carbonation reactor. In various embodiments, the carbonation reactor may be insulated to reduce heat escape and/or regulate temperature. For example, the carbonation reactor may be wrapped with heating-tape and insulated.

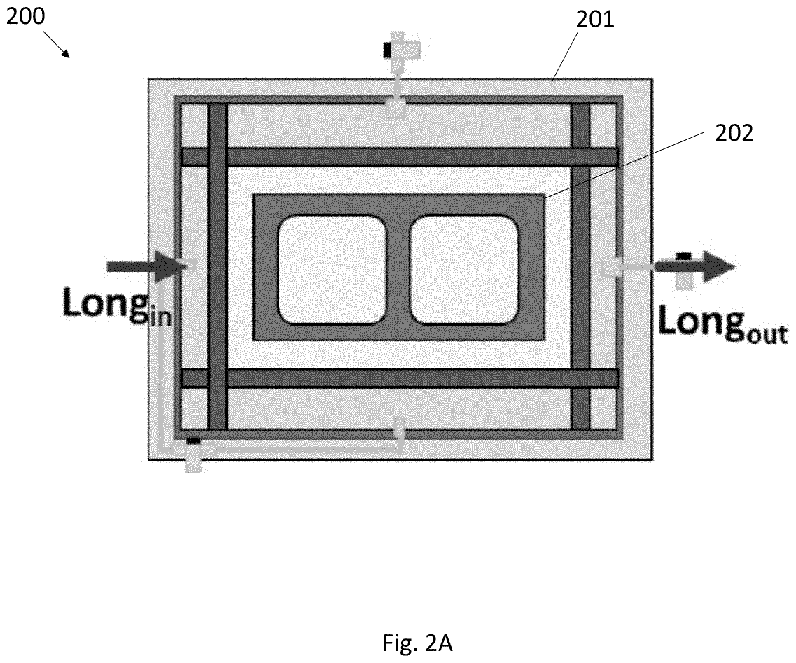

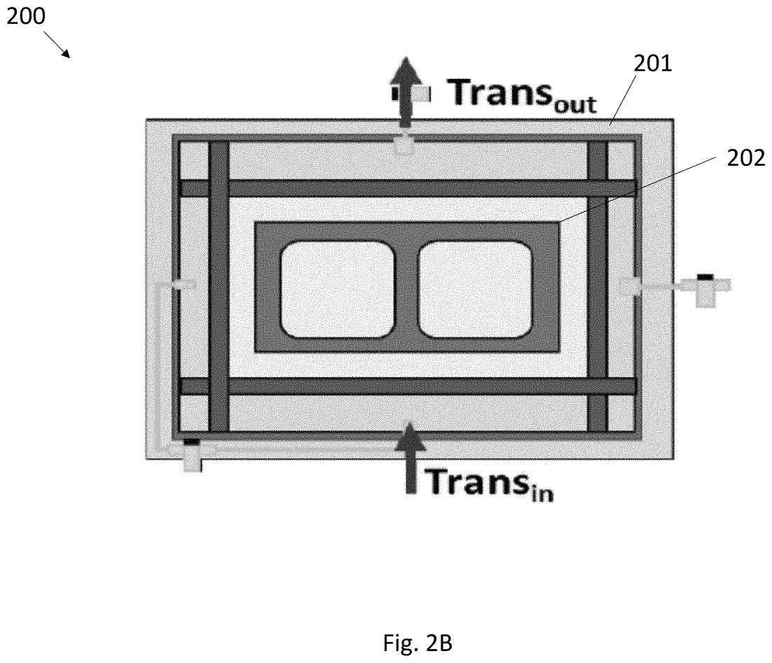

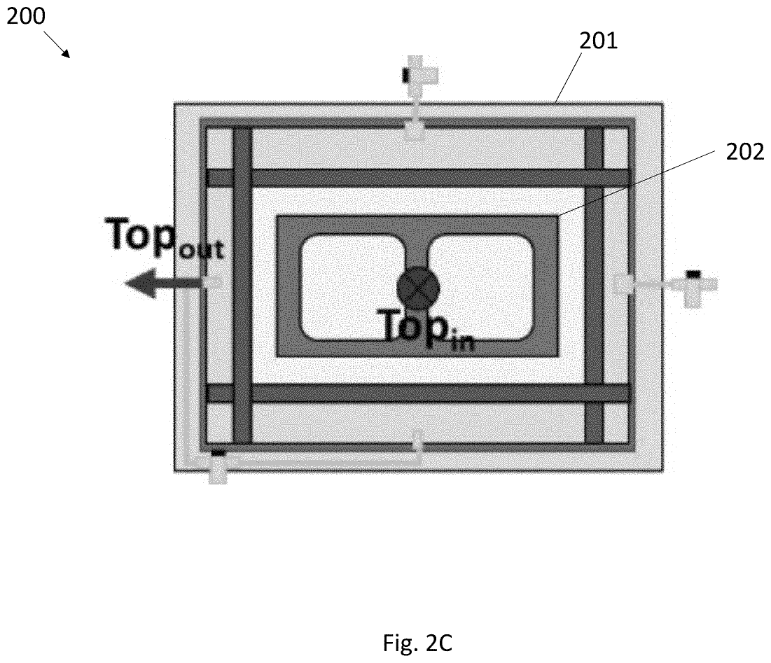

FIGS. 2A-2C illustrate inlet and outlet positions of the gas stream for longitudinal flow (FIG. 2A), transverse flow (FIG. 2B), and top flow (FIG. 2C) configurations of the carbonation reactor 201. In various embodiments, the flow configuration is defined based on dimensions (e.g., length, width, height) of the carbonation reactor. As shown in FIG. 2A, a longitudinal flow configuration receives a gas stream of CO₂ through a side wall of the carbonation reactor 201, flows the gas along a length (e.g., a long side) of the carbonation reactor, and out of the opposite side wall of the carbonation reactor. In various embodiments, the long side of the carbonation reactor corresponds to a long side of the object (e.g., a block, a beam having a rectangular or square cross-section, an I-beam, a cylindrical pole, etc.) being carbonated. As shown in FIG. 2B, a transverse flow configuration receives a gas stream of CO₂ through a side wall of the carbonation reactor 201, flows the gas along a width (e.g., a short side) of the carbonation reactor, and out of the opposite side wall of the carbonation reactor. In various embodiments, the short side of the carbonation reactor corresponds to a short side of the object being carbonated. Where the carbonation reactor has equal length and width, the longitudinal and transverse flow configurations may be interchangeable.

In various embodiments, the flow configuration is defined based on dimensions (e.g., length, width, height) of the object being carbonated. As shown in FIG. 2A, a longitudinal flow configuration receives a gas stream of CO₂ through a side wall of the carbonation reactor 201, flows the gas along a length (e.g., a long side) of the object being carbonated, and out of the opposite side wall of the carbonation reactor. In various embodiments, the long side of the carbonation reactor corresponds to a long side of the object being carbonated. As shown in FIG. 2B, a transverse flow configuration receives a gas stream of CO₂ through a side wall of the carbonation reactor 201, flows the gas along a width (e.g., a short side) of the object being carbonated, and out of the opposite side wall of the carbonation reactor. In various embodiments, the short side of the carbonation reactor corresponds to a short side of the object being carbonated. Where the object being carbonated has equal length and width, the longitudinal and transverse flow configurations may be interchangeable.

In various embodiments, for longitudinal and transverse flow configurations shown in FIGS. 2A-2B, the gas inlet and outlet are positioned in the middle of the reactor sidewalls.

As shown in FIG. 2C, a top flow configuration receives a gas stream of CO₂ through a top wall of the carbonation reactor 201, flows the gas along a height of the carbonation reactor, and out of one or more side walls of the carbonation reactor. In various embodiments, for top flow configuration shown in FIG. 2C, the gas inlet is located in the middle of the reactor's lid and a longitudinal outlet was used.

To assess the effect of gas flow distribution on carbonation, various gas flow configurations (e.g., longitudinal, transverse, and top flow) were analyzed. Second, to systematically evaluate the interactions between gas processing parameters (T, RH, and Q) for a single flow configuration, a factorial Design-of-Experiments (DoE) approach was implemented (see Table 2 below). The significance of variables and their interactions were determined by the analysis of variance (ANOVA) approach using least-squares fitting. A non-linear regression analysis was used to derive statistical prediction models and develop response surfaces. The results of statistical models were then integrated into a multivariable optimization algorithm to determine the optimal parameters that satisfy the performance targets. Here, for defined targets, the desirability functions dᵢ are obtained and simultaneously optimized to determine their best combination as quantified by the overall desirability D function:

D=(d₁^{r}^{₁}×d₂^{r}^{₂}×d₃^{r}^{₃}× . . . ×dₙ^{r}^{ₙ})/Σrᵢ (Eq. 1)

where n is the number of individual responses in the optimization, and rᵢ refers to the relative importance of each property, which varies from 1 to 5, reflecting the smallest to the highest degree of importance, respectively. And, dᵢ ranges between 0 (i.e., least desired response) and 1 (i.e., most desired response). Hereafter, the concrete blocks were dried by exposure to flowing air to achieve different initial S_{w}, prior to the carbonation process. The temperature, relative humidity, and flow rate during the drying step were equivalent to those applied during carbonation, with the exception of using an air stream (i.e., [CO₂]=0.04%) during drying rather than simulated flue gas ([CO₂]=12.5%) that was used during carbonation.

In various embodiments, the concrete block is sampled across different sections including: each side (long dimension), each face (short dimension), and the web (e.g., the interior wall between the two hollows) to assess the variations in CO₂ uptake across different sections. For sampling, a rotary hammer with a 6 mm drill-bit may be used to extract powders through the entirety of the section's thickness. The total CO₂ uptake (CO₂, total) within a block was estimated as a mass average of each section's CO₂ uptake as:

CO_{2,total}=Σᵢ₌₁^{n=k}C(24 h)ᵢ(g_{CO}_{₂}/g_{reactants})×mᵢ (Eq. 2)

where C(24 h) is the 24-h CO₂ uptake of the i^{th} section (i.e., side, face, or web) and m; refers to the mass fraction of a section in relation to the entire block mass. Thermogravimetric analysis was used to assess the extent of CO₂ uptake following ASTM C1872. Around 50 mg of powder was heated from 35° C. to 975° C. at a rate of 15° C./min in aluminum oxide crucibles under ultra-high purity N₂ gas purge at a flow rate of 20 mL/min. The carbonate content was quantified by assessing the mass loss associated with CaCO₃ decomposition over the temperature range of 550° C. to 950° C., normalized by the initial mass of reactants (g_{CO2}/g_{reactants}; reactants: portlandite, fly ash, and OPC) within the solid. In various embodiments, CO₂ uptake accounted for the initial quantity of carbonates that were present in the precursor materials prior to the carbonation process. In addition to carbonate content, the non-evaporable water content (wₙ, mass %) was calculated as the mass loss over the temperature range of 105° C. to 975° C., excluding the mass loss from the decomposition of CaCO₃ and Ca(OH)₂ to estimate the extent of cement (OPC) hydration.

The net area compressive strengths of the concrete blocks were measured in accordance with ASTM C140 under uniaxial monotonic displacement-controlled loading using a hydraulic jack with a capacity of 800 kN. The bearing plates used for compression testing were large enough to cover the contact surfaces of the block entirely to distribute the load evenly, and rigid enough (100 mm thick) to eliminate plate bending that can cause non-uniform stresses. To characterize the variations of carbonate mineral formation, the porosity and compressive strength of the different block's sections (i.e., sides, web, and faces) were determined. Representative samples (50 mm×50 mm×25 mm; l×w×t) were cut from the middle of each section of the concrete block using a low-speed saw. The total porosity and pore saturation level of samples were quantified using a vacuum saturation method and the compressive strengths of the samples were measured as per ASTM C39. In various embodiments, to assess the effects of gas processing conditions on the transport properties (diffusion), the total moisture diffusion coefficient (i.e., the sum of liquid water and water vapor diffusion coefficients) was estimated using Fick's 2^{nd} law. Herein, the sides of the sectioned samples (50 mm×50 mm×25 mm; l×w×t) were double-sealed using adhesive-backed aluminum tape to ensure 1D gas transport (exposed surfaces: 50 mm×50 mm; l×w).

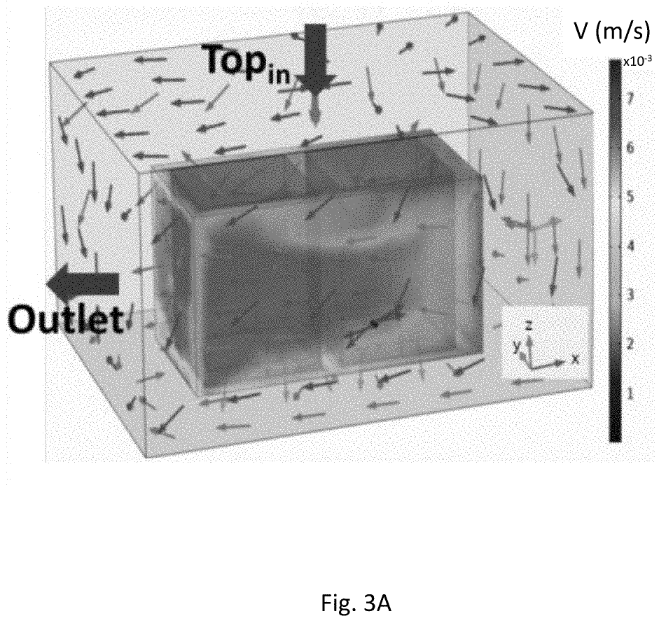

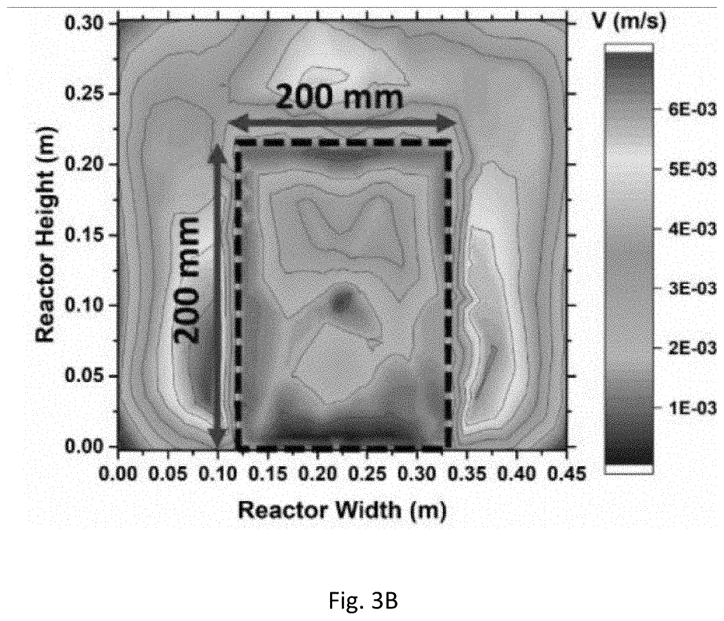

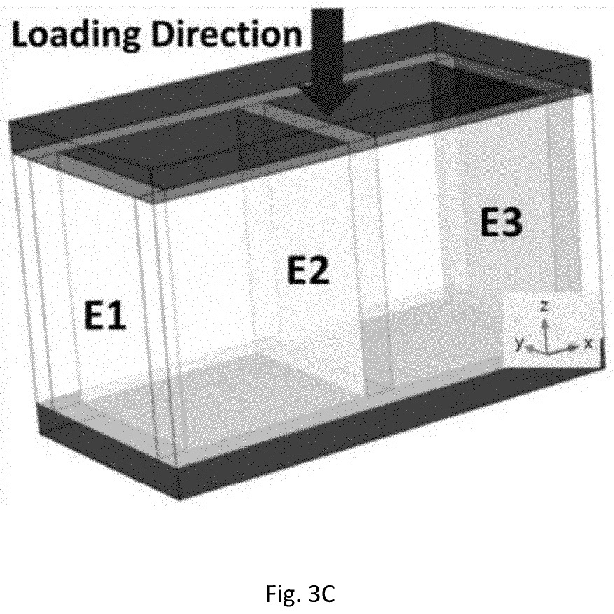

In various embodiments, CFD simulations are used to assess the effects of gas flow configurations on the spatial distribution and velocity of contacting gas across the concrete block's surfaces within the carbonation reactor. In various embodiments, the gas flow analysis was carried out using the k−ω turbulence model, which is suitable for gas velocity analysis near solid wall regions. The Reynolds number Re based on inlet diameter dᵢₙₗₑₜ and inlet velocity Vᵢₙₗₑₜ was calculated to be greater than 2,300 suggesting turbulent flow. In the k−ω model, the turbulent kinetic energy k and specific turbulent dissipation rate ω describe the turbulence of gas flow. FIG. 3A shows a representative CFD simulation of the gas flow distributions across the concrete block surfaces within the carbonation reactor for the top flow direction. The boundary conditions used in the simulations included the gas inlet velocity (Vᵢₙₗₑₜ=Qᵢₙₗₑₜ/Aᵢₙₗₑₜ, and outlet gas pressure (Pₒᵤₜₗₑₜ=0). The model's mesh consisted of 25,000 tetrahedral elements for the concrete blocks and 10,000 triangular elements for the reactor walls. The size of elements ranged from 0.005 m to 0.01 m for concrete block and reactor domains, respectively. To quantify the average contacting gas velocity and velocity non-uniformity, the gas flow field for every surface of the concrete block was discretized into cells and their corresponding velocity magnitudes were extracted, as shown in FIG. 3B. In various embodiments, the average contacting gas velocity across the i^{th} surface of the concrete block V_{ave,i} is quantified as:

$${V}_{ave , i} = \frac{{\sum }_{x = 1}^{n} {V}_{x}}{n} \qquad ( Eq . 3 )$$

where n is the number of cells (5 mm×5 mm) on the block surface and Vₓ corresponds to the velocity magnitude in each cell. To rationalize the data, in all cases, the average contacting gas velocity V_{ave,i}, was normalized by the gas inlet velocity Vᵢₙₗₑₜ. The degree of non-uniformity (i.e., variation) of the contacting gas velocity across the block surfaces was then quantified as:

$$Velocity Non \text{-} uniformity Index = \frac{\sqrt{\frac{1}{n} {\sum }_{x = 1}^{n} {( {V}_{x} - {V}_{ave , i} )}^{2}}}{{V}_{ave , i}} \qquad ( Eq . 4 )$$

In various embodiments, FEM analysis of the linear elastic behavior of the concrete block may be performed to assess the effect of stiffness variations resulting from CO₂ uptake across the different block's sections on the overall mechanical response of the concrete block. The measured strength data of the block's sections was used to estimate material stiffness as an input in the FEM analysis as follows:

E_{c,i}=kσ_{c,i} (Eq. 5)

where E_{c,i}, (MPa) and ac (MPa) are Young's modulus and compressive strength, respectively, of the i^{th} section of the concrete block and k is the coefficient relating elastic modulus to the compressive strength that was taken as 900 herein. For dry-cast composites such as concrete blocks on account of their high aggregate contents, the elastic modulus is dictated by the stiffness of aggregate inclusions and degree of compaction. As such, no distinction in elastic modulus is expected between traditional cement-based and carbonated concrete blocks. The estimated Young's moduli of the sections were input in the FEM analysis to simulate the concrete block analyzed in FIG. 3C.

To mimic compressive loading and minimize local stress concentrations, steel bearing plates were modeled as well. As the boundary conditions, the displacements of the bottom plate were taken as zero in all directions (x, y, and z) and compressive stress was applied to the top surface by systematically increasing the applied stress from 0 to 15 MPa in 1.5 MPa increments. Perfect contact between the bearing steel plates and the surfaces of the concrete block was prescribed.

FIG. 3A illustrates a computational fluid dynamics (CFD) simulation of gas flow distributions across the surfaces of a concrete block within the carbonation reactor for the top flow configuration. FIG. 3B illustrates a contour plot of the gas velocity field across the surfaces of the concrete block. FIG. 3C illustrates a finite element method (FEM) simulation of uniaxial compression of the carbonated block showing sections (i.e., sides, faces, and web) with different Young's moduli.

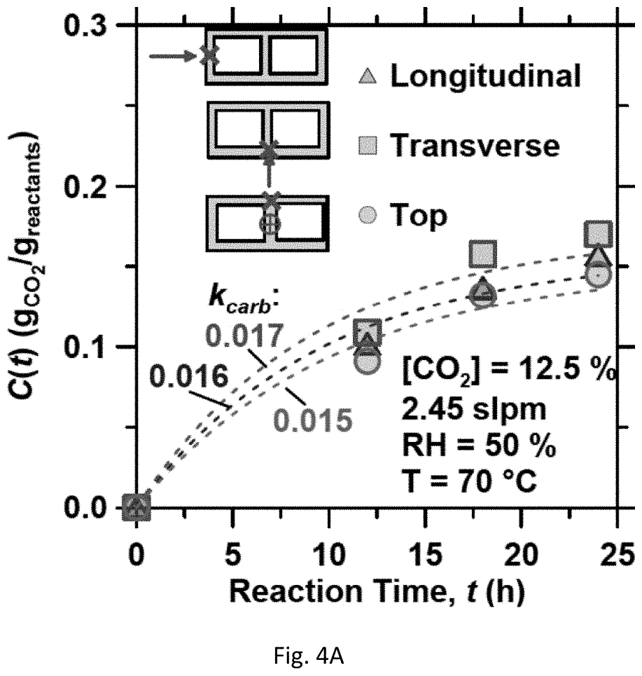

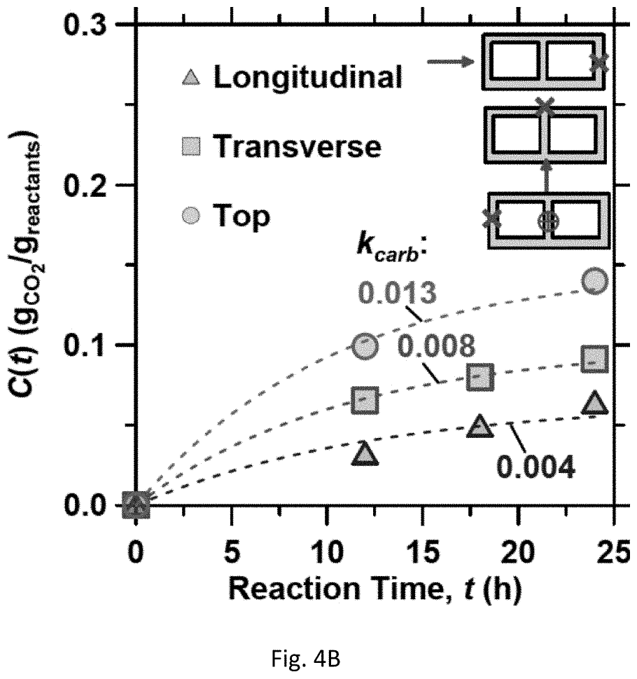

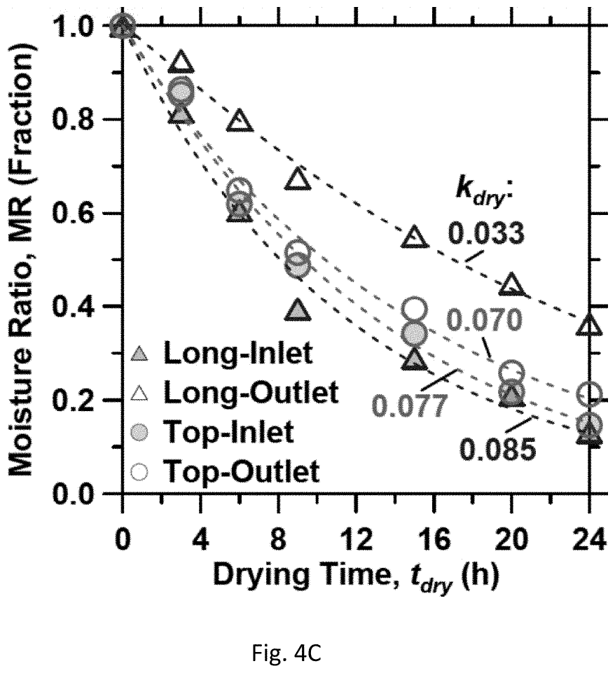

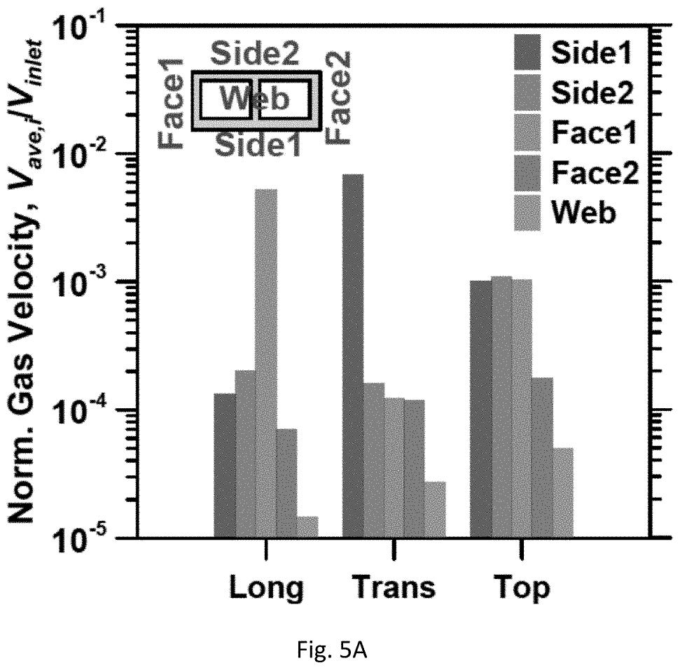

FIGS. 4A-4B illustrate graphs of the time-dependent traces of the CO₂ uptake of the concrete block sections for different gas flow configurations for: inlet and outlet positions. FIG. 4C illustrates the evolution of the moisture ratio for different sections of the concrete block for varying gas flow configurations. The time-dependent CO₂ uptakes of different sections of the concrete blocks for different gas flow configurations were evaluated. In various embodiments, CO₂ uptake varies based on the gas flow configuration. Although all inlet faces featured nearly similar CO₂ uptake-time profiles (shown in FIG. 4A), the CO₂ uptake profiles of the outlet faces were expectedly impacted by the gas flow configuration (shown in FIG. 4B). Unlike significant CO₂ uptake variations between different block's sections for both longitudinal and transverse flow configurations, the top flow featured the most uniform CO₂ uptake and the highest CO₂ uptake. The overall 24-h CO₂ uptake was 0.089 gCO₂/greactants, 0.121 gCO₂/greactants, and 0.150 gCO₂/greactants for the longitudinal, transverse, and top flow configurations, respectively. To quantify the effect of the flow configuration on carbonation kinetics, the time-CO₂ uptake profiles were fitted to an equation of the form

C(t)=C(tᵤ)(1−exp[(−k_{carb}t)/C(tᵤ)]) (Eq. 6)

where k_{carb} is the apparent carbonation rate constant and C(tᵤ) is the ultimate CO₂ uptake that was taken as the 24-h CO₂ uptake. Similar to CO₂ uptake, the carbonation rate constant for the different sections indicated a strong dependency on gas flow configuration. For instance, k_{carb}, for block's section facing the gas outlet was 4× lower than that of the inlet for the longitudinal direction, while near equivalent carbonation kinetics for both sections were observed for the top flow configuration.

In various embodiments, the suppression of carbonation kinetics across some of the block sections is on account of higher water content in the block's pores (i.e., higher S_{w}) that was imposed by insufficient drying within sections whose surfaces are starved of gas flow. In various embodiments, the presence of water within the pores of microstructure inhibits carbonation by imparting CO₂ mass transfer resistance. In various embodiments, to assess the drying kinetics as a function of different gas flow configurations, the moisture ratio (MR) evolution is evaluated. To exclude the competing effects of carbonation and moisture transport, the concrete block was exposed to flowing air that was conditioned similarly (T, RH, and Q) to the carbonation experiments. The drying rate constant k_{dry} was estimated as

MR(t)=exp[−k_{dry}tⁿ] (Eq. 7)

where n is the fitting exponent and MR(t) is the dimensionless moisture ratio at time t, which is given as

MR(t)=(ωₜ−ωₑ)/(ω₀−ωₑ) (Eq. 8)

where ωₜ, ωₑ, and ωₒ are moisture content at time t, the equilibrium moisture content, and initial moisture content, respectively. Generally, the drying rate dMR(t)/dt decreases with time due to the transition from connected-liquid bridge drying to vapor diffusion as the drying front progressively penetrates deeper into the body. In agreement with the results of carbonation kinetics, the top flow configuration resulted in more uniform drying kinetics between inlet and outlet sections than that of the longitudinal flow, as shown in FIG. 4C. The similarity between carbonation and drying behavior of the concrete block sections shows that the carbonation rate constant k_{carb} is strongly correlated with and controlled by the drying rate constant k_{dry}, since enhanced drying facilitates CO₂ diffusion and thereby promotes the carbonation kinetics. This suggests that the variation of CO₂ uptake is induced on account of the different distributions of water content and drying front penetration across block's sections which affect gas diffusion (i.e., since gas diffusion in water ˜10⁴ times slower than in air).

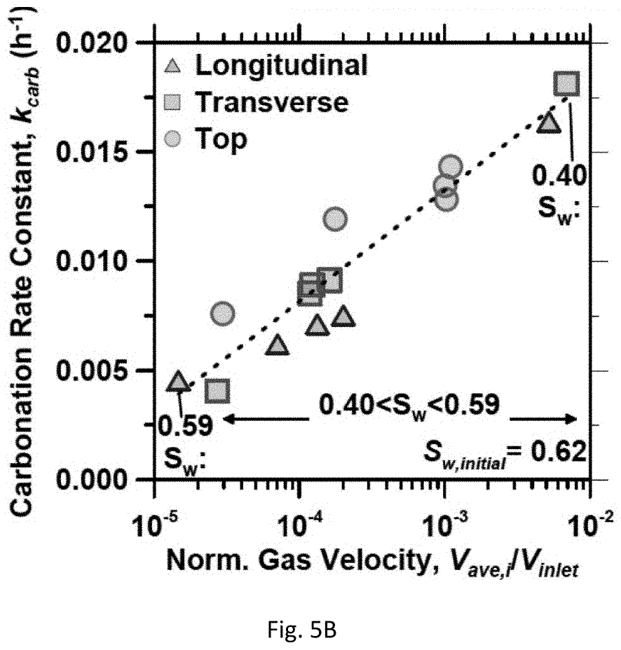

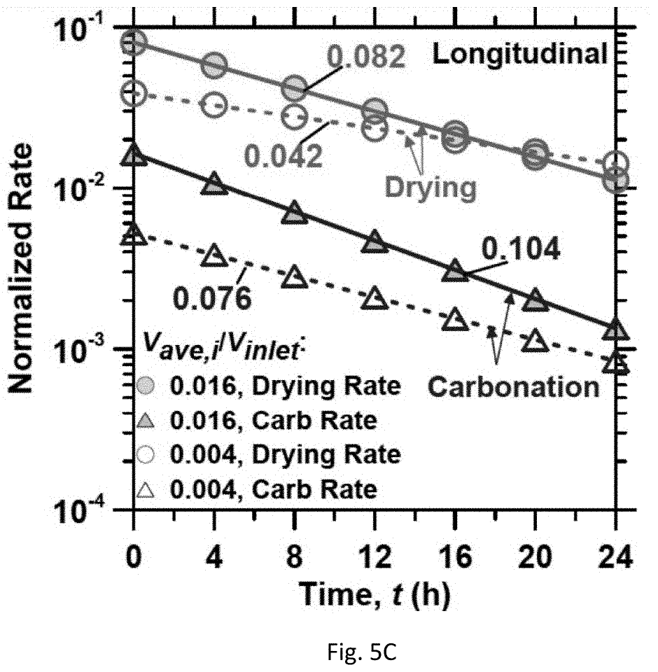

FIG. 5A illustrates a CFD analysis of contacting gas velocity across different block surfaces for varying gas flow configurations. FIG. 5B illustrates a graph of the evolution of the apparent carbonation rate constant as a function of contacting gas velocity. FIG. 5C illustrates a graph of representative drying rate and carbonation rate at different contacting velocities.

In various embodiments, variations in drying kinetics across the different sections of the block are due to the spatial variations of the contacting gas velocity. In various embodiments, CFD analysis revealed that the top flow configuration resulted in the most-spatially uniform and the highest average velocity across block's surfaces, as shown in FIG. 5A. In various embodiments, the top flow configuration has more uniform and higher CO₂ uptake. The evolution of carbonation rate constant k_{carb} showed a logarithmic scaling as a function of contacting gas velocity, as shown in FIG. 5B. This suggests that the overall carbonation reaction rate is controlled by the overall drying rate, since a higher drying rate enhances the penetration of the drying front*, as evidenced by the reduced S_{w} from 0.62 to 0.40. In turn, increasing the contacting gas velocity by three orders of magnitude resulted in a proportionate 3.5× enhancement of carbonation rate, as shown in FIG. 5B. In various embodiments, the contacting gas velocity diminishes significantly within the web section thereby resulting in the lowest carbonation level among all sections of the concrete block (shown in FIG. 5A) in the occluded web independent of the gas flow configuration. This diminished contacting gas velocity on account of the low length-to-depth ratio (LID=1) of the concrete block hollows, as a result of which marginal flow occurs within the core-sections suggesting the formation of dead regions (V=0). A greater initial drying rate and faster drying resulted in a greater carbonation rate at early ages followed by a faster decrease in the carbonation rate as evidenced by the profiles shown in FIG. 5C. Although the rate of penetration of the drying front increases with gas velocity, the enhanced formation of carbonate minerals (CaCO₃) in the direction of the drying front can produce blockages in the microstructure. This can impose an additional transport limitation that can suppress the carbonation rate at later reaction times. In various embodiments, the effect of the contacting gas velocity on moisture transfer within the pore spaces is affected by the gas processing conditions (T and/or RH). For instance, for a given contacting gas velocity, increasing the RH of the gas stream slows moisture transport and penetration of drying front due to the competition between inward and outward transport of (condensed) moisture within the pores, as discussed in the next section.

In various embodiments, the carbonation rate is at least 0.005. In various embodiments, the carbonation rate is at least 0.0075. In various embodiments, the carbonation rate is at least 0.01. In various embodiments, the carbonation rate is at least 0.025. In various embodiments, the carbonation rate is at least 0.05. In various embodiments, the carbonation rate is at least 0.075. In various embodiments, the carbonation rate is at least 0.1. In various embodiments, the carbonation rate is at least 0.15. In various embodiments, the carbonation rate is at least 0.2. In various embodiments, the carbonation rate is at least 0.25. In various embodiments, the carbonation rate is at least 0.3. In various embodiments, the carbonation rate is at least 0.35. In various embodiments, the carbonation rate is at least 0.4. In various embodiments, the carbonation rate is at least 0.45. In various embodiments, the carbonation rate is at least 0.5. In various embodiments, the carbonation rate is at least 0.55. In various embodiments, the carbonation rate is at least 0.60. In various embodiments, the carbonation rate is at least 0.65. In various embodiments, the carbonation rate is at least 0.7. In various embodiments, the carbonation rate is at least 0.75. In various embodiments, the carbonation rate is at least 0.8. In various embodiments, the carbonation rate is at least 0.85. In various embodiments, the carbonation rate is at least 0.9. In various embodiments, the carbonation rate is at least 0.95.

In various embodiments, the carbonation rate is from about 0.005 to about 1. In various embodiments, the carbonation rate is from 0.01 to about 1. In various embodiments, the carbonation rate is from 0.05 to about 1. In various embodiments, the carbonation rate is from 0.1 to about 1. In various embodiments, the carbonation rate is from 0.15 to about 1. In various embodiments, the carbonation rate is from 0.2 to about 1. In various embodiments, the carbonation rate is from 0.25 to about 1. In various embodiments, the carbonation rate is from 0.3 to about 1. In various embodiments, the carbonation rate is from 0.35 to about 1. In various embodiments, the carbonation rate is from 0.4 to about 1. In various embodiments, the carbonation rate is from 0.45 to about 1. In various embodiments, the carbonation rate is from 0.5 to about 1. In various embodiments, the carbonation rate is from 0.55 to about 1. In various embodiments, the carbonation rate is from 0.6 to about 1. In various embodiments, the carbonation rate is from 0.65 to about 1. In various embodiments, the carbonation rate is from 0.7 to about 1. In various embodiments, the carbonation rate is from 0.75 to about 1. In various embodiments, the carbonation rate is from 0.8 to about 1. In various embodiments, the carbonation rate is from 0.85 to about 1. In various embodiments, the carbonation rate is from 0.9 to about 1. In various embodiments, the carbonation rate is from 0.95 to about 1.

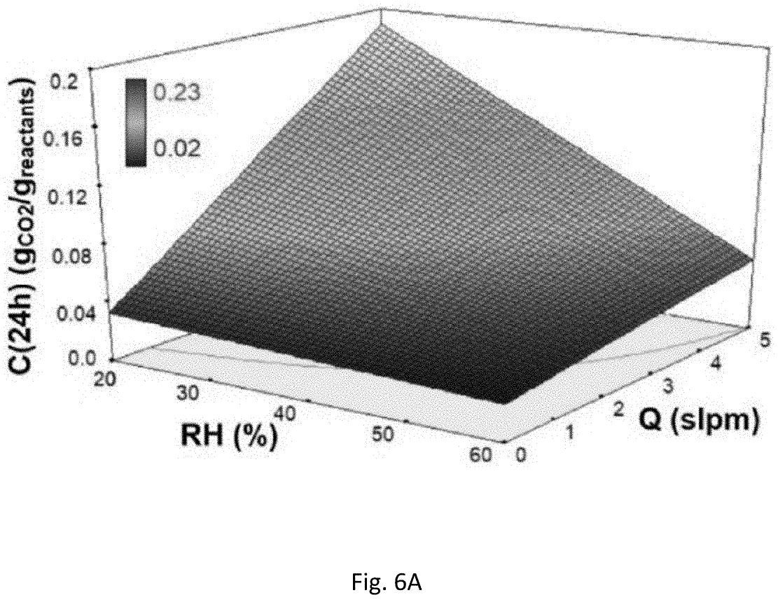

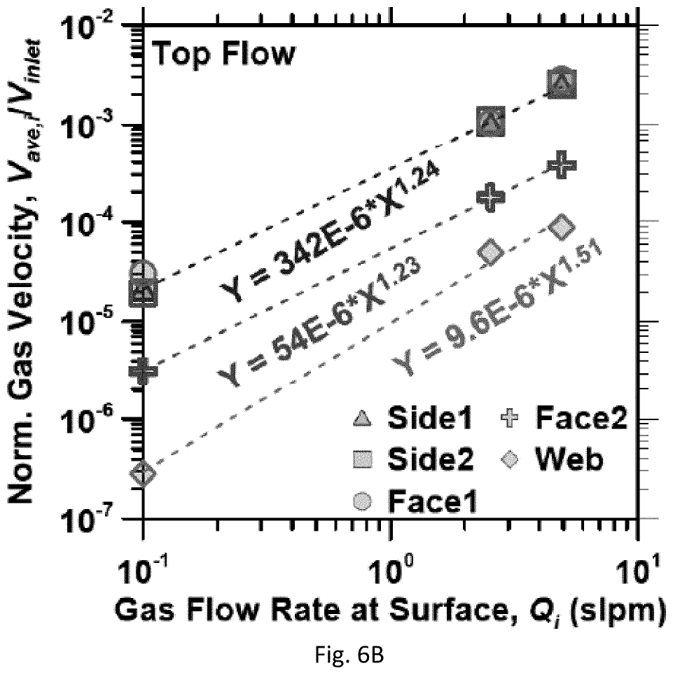

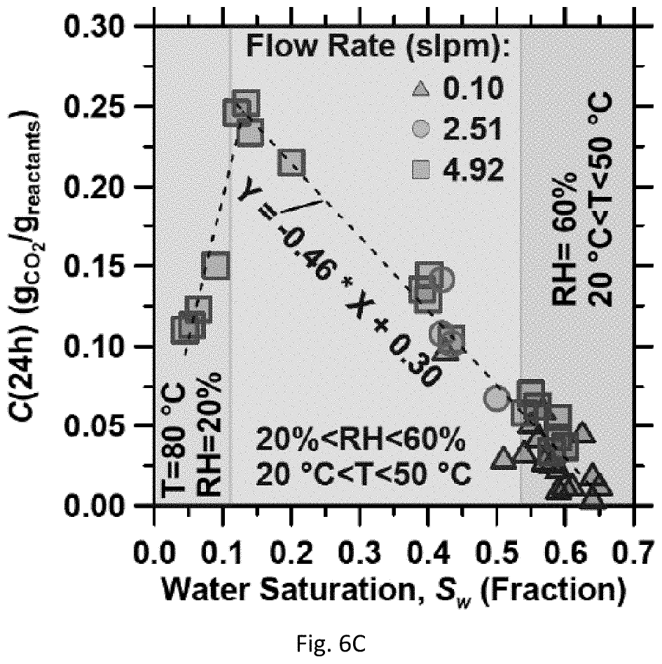

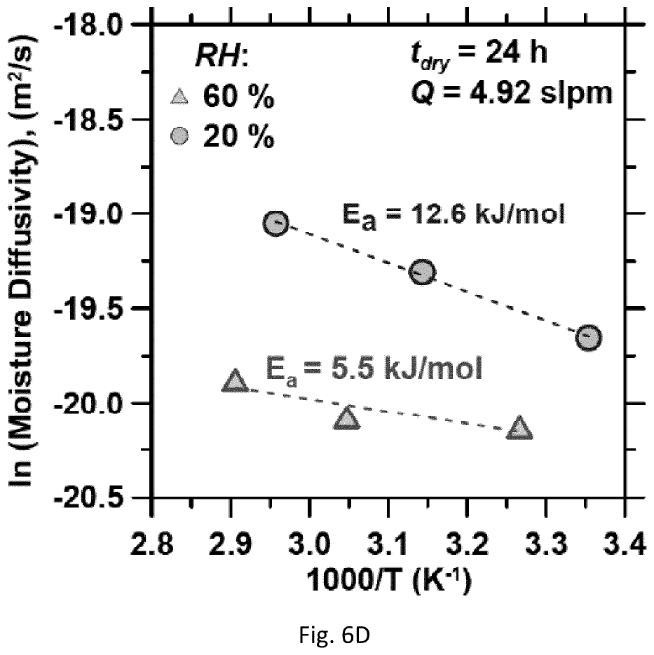

FIG. 6A illustrates a surface plot of the 24-h CO₂ uptake of a concrete block under different relative humidity (RH) and flow rate (Q) of gas at T=35° C. FIG. 6B illustrates a graph of the variations of contacting gas velocity as a function of flow rate for different block surfaces. FIG. 6C illustrates a graph of the variations in 24-h CO₂ uptake as a function of initial pore water saturation (S_{w}) after the drying step. FIG. 6D illustrates Arrhenius plots of the activation energy of moisture diffusion (Eₐ) at different gas RH during drying. Effects of interactions between gas processing conditions on carbonation reaction: for a given gas flow configuration, the carbonation of concrete composites is strongly influenced by the gas processing parameters (T, RH, and Q). To systematically assess such effects and their interactions, a factorial Design-of-Experiments (DoE) approach was used to generate response surfaces and derive statistical prediction models. To vary the initial pore saturation level S_{w,initial}, the blocks were initially dried by exposure to flowing air prior to the carbonation process. The ANOVA results are listed below in Table 3, which indicates the significant parameters and interactions. As an example, the response surface of CO₂ uptake visualizes the combined effect of RH and Q of gas (see FIG. 6A). The statistical models for S_{w}, after drying and 24-h CO₂ uptake of concrete blocks were derived as:

S_{w,i drying}=0.62890−0.00397×T+0.00198×RH−0.07348×Qᵢ+0.00111(RH×Qᵢ) (Eq. 9)

C(24 h)ᵢ=−0.00592+0.00127×T−0.00022×RH+0.04373×Qᵢ−0.00064(RH×Qᵢ) (Eq. 10)

The significant parameters and interactions were found to be identical between both responses, although having opposite signs, demonstrating the significance of S_{w}, as a dominant variable that affects the carbonation of concrete composites. Hereafter, to predict the CO₂ uptake of the different block's sections, the variations in the contacting gas velocity as a function of gas inlet flow rate were determined using CFD analysis. Increasing the flow rate at the gas inlet enhanced the contacting gas velocity and improved the velocity uniformity across different block surfaces, shown in FIG. 6B. For a given block surface, the correlation between normalized contacting velocity and gas flow rate can be described by the power function of the form:

V_{ave,i}/Vᵢₙₗₑₜ=aQᵢ^{b} (Eq. 11)

where a and b are fitting parameters that depend on the concrete block section, shown in FIG. 6B.

Knowledge of the normalized contacting gas velocity and the corresponding gas flow rate Q; (using Eq. 11) allows prediction of the average CO₂ uptake for a given concrete block's section using Eq. 10 for this specific reactor configuration.

In various embodiments, for pore water saturation, the 24-h CO₂ uptake of the block sections scales with S_{w,drying} (shown in FIG. 6C), as estimated by a linear function of the form:

C(24 h)ᵢ=−0.46×S_{w,i}+0.30 for S_{w}>0.11 (Eq. 12)

In various embodiments, S_{w,c}≈0.10 may sustain the dissolution-carbonation reaction of portlandite. To capture this breakpoint, a separate dataset (outside the design space) was collected under aggressive drying at T=80° C. and RH=20% that revealed that CO₂ uptake was substantially suppressed when S_{w} dropped below 0.11. In various embodiments, Eqs. 9, 10, and 12 are valid for S_{w}>S_{w,c}≈0.10. In various embodiments, CO₂ mineralization mechanism via portlandite carbonation within concrete monoliths occurs via a dissolution-precipitation pathways including: (i) release of Ca²⁺ species into the pore liquid due to dissolution of alkaline reactants, (ii) transport and dissolution of CO₂ though and within the monolith's pore network, and/or (iii) precipitation of carbonate minerals via combination of dissolved species (Ca²⁺, CO₃²⁻, and HCO₃⁻). In various embodiments, when S_{w,c} is exceeded, Ca²⁺ species liberated following the dissolution of portlandite react with dissolved CO₂ species (i.e., CO₃²⁻ and HCO₃⁻) to precipitate calcium carbonate.

In various embodiments, CO₂ uptake is limited when gas RH was similar to the initial S_{w}=0.62 of the concrete block (see the shaded region in FIG. 6C). In various embodiments, a small driving force causes evaporation, and a balance between moisture transport into and out of the pore structure, such that drying is hindered. This was evidenced by quantifying the apparent activation energy of moisture diffusion (see FIG. 6D). In various embodiments, Arrhenius analysis of moisture diffusivity at RH=60% shows a small dependence on temperature as compared to moisture diffusion at RH=20%. In various embodiments, the small apparent activation energy (<20 kJ/mol) is reflective of limited temperature sensitivity for drying of the monoliths; and indicates a transport controlled, i.e., rather than surface reaction-controlled process. In various embodiments, at RH=60% (Eₐ≈5.5 kJ/mol), wherein the contacting gas's relative humidity is similar to the pore water saturation of the concrete block (S_{w}=0.62), drying is hindered due to the similar rates of moisture transfer inward from the ambient environment and outward from pore network. In various embodiments, as the RH of the contacting gas stream is reduced, moisture removal becomes somewhat more sensitive to temperature (e.g., a 3× reduction in the RH translates to only a doubling of the activation energy). In various embodiments, the activation energies of moisture diffusion are lower than that reported for mature, hardened cement paste (e.g., ˜32-45 kJ/mol for water-to-cement ratio=0.40-0.60); under conditions where no air-flow occurred. The smaller temperature dependence (Eₐ) of moisture diffusivity in the presence of air flow is likely because air flow facilitates moisture transport due to a sharper, and sustained RH gradient between the ambient vapor and the monolith's surface from where evaporation occurs. In various embodiments, both optimal reactor (gas) flow distribution and gas processing conditions may enhance carbonation kinetics and carbonation uniformity within concrete composites.

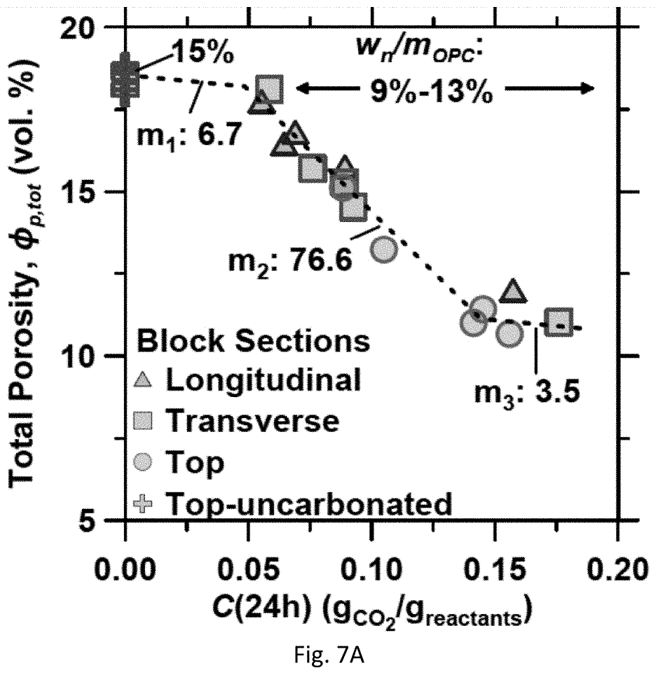

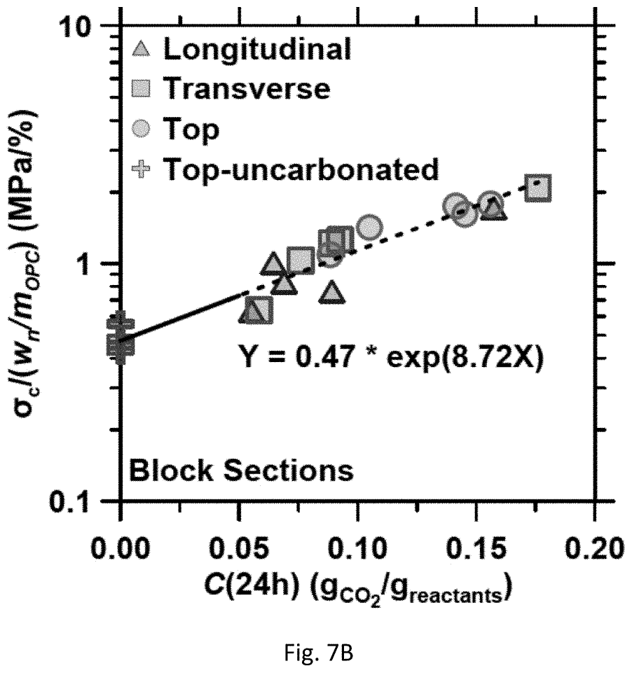

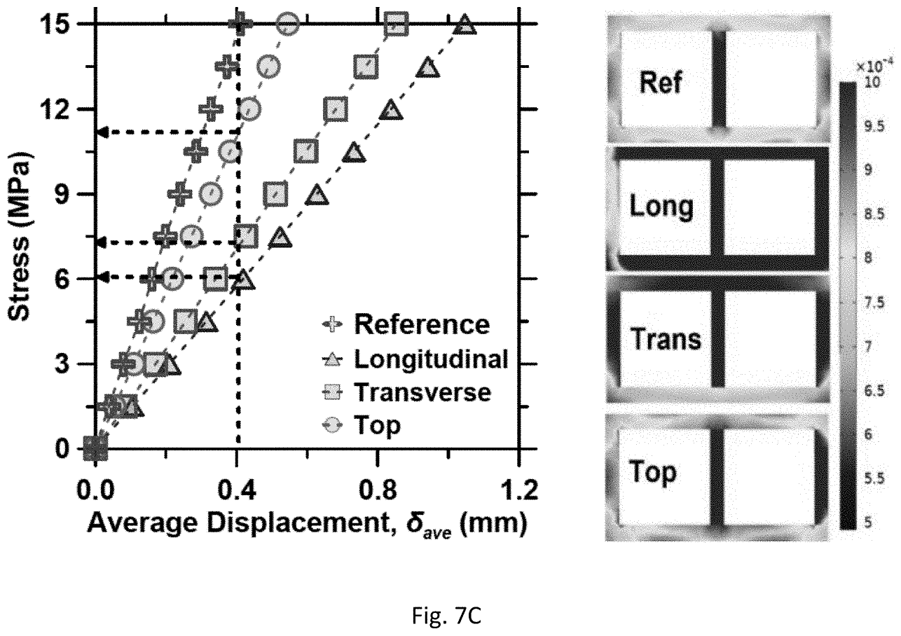

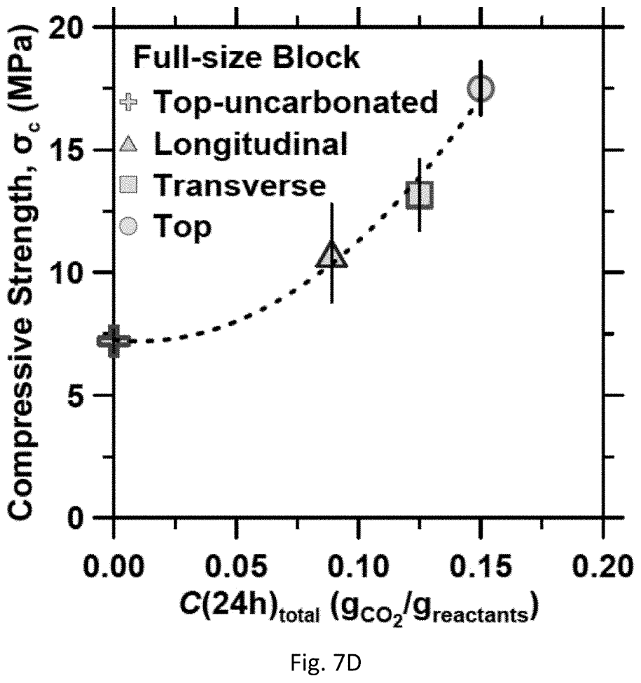

FIG. 7A illustrates a graph of the variations in porosity across different sections of carbonated blocks as a function of CO₂ uptake under different gas flow configurations. FIG. 7B illustrates a graph of the normalized strength evolution as a function of the CO₂ uptake for different sections of concrete blocks. FIG. 7C illustrates a graph of the FEM analysis of the uniaxial compressive stress-displacement response of carbonated concrete blocks. The Young's modulus of every section was estimated using [Eq. 5]. The reference concrete block was modeled using a homogenous Young's modulus of 14 GPa. Strain distributions across top surfaces of concrete blocks at σ_{c}=15 MPa are shown. FIG. 7D illustrates a graph of the compressive strength as a function of the CO₂ uptake for different gas flow configurations. During carbonation, the gas stream featured [CO₂]=12.5%, T=70° C., RH=50%, and 2.45 slpm flow rate.

In various embodiments, the strengthening of concrete composites during CO₂ exposure is affected by cement hydration, pozzolanic, and carbonation reactions. As the extent of CO₂ uptake determines carbonate cementation, variations in CO₂ uptake can induce non-uniformity in carbonation strengthening, which can impact the overall mechanical response of carbonate-cemented components. In various embodiments, the porosity of carbonated samples that were extracted from different sections of the concrete block demonstrated a sigmoidal/tri-linear refinement with CO₂ uptake, as shown in FIG. 7A. On account of more uniform CO₂ uptake, the top flow configuration resulted in a lower porosity and smaller variations in porosity across different block's sections as compared to the longitudinal and transverse flow directions. The tri-linear trend indicated a secondary slope m₂=76.6 (i.e., between 0.05 g_{CO2}/g_{reactants} and 0.15 g_{CO2}/g_{reactants}) that was substantially steeper than the first and third slopes (m₁=6.7 and m₃=3.5) on account of the enhanced formation of space-filling carbonate products. The smaller slope m₁ is attributed to the small extent of cement hydration (wₙ/m_{OPC}) and minimal carbonation. The smallest slope m₃ results from a near-complete conversion (i.e., carbonation) of portlandite (≈85% based on TGA analysis) which is the primary reactant used for CO₂ mineralization in the concrete monolith. As a result, the contribution of carbonation to porosity refinement saturates as portlandite carbonation reaches the final conversion extent. To exclude the effect of cement hydration, the compressive strength results were normalized by wₙ/m_{OPC} and plotted as a function of CO₂ uptake, as shown in FIG. 7B. In various embodiments,

$$σ c \text{/} ( Wn \text{/} {m}_{OPC} )$$

enhanced exponentially with an exponent of 8.72 per unit mass of CO₂ uptake, confirming that strengthening offered by carbonation is advantageously increases strength of the structural component. Additionally, the extrapolation of the curve to determine the y-intercept (see solid line in FIG. 7B) yielded nearly an equivalent value to that of uncarbonated concrete block suggesting that carbonation does not detrimentally affect the strength gain resulting from cement hydration.

Because of lower CO₂ uptake, the smallest compressive strength was observed for the web sections of carbonated concrete block. The variations in material strength and elastic properties across the concrete block sections can result in non-uniform stress and displacement distributions under loading. This is confirmed by FEM simulations of the stress-displacement response of concrete blocks, as shown in FIG. 7C. In contrast to top flow, concrete blocks carbonated under the longitudinal and transverse flow directions have more non-uniform strain distributions, and as a result, the compressive strength reduced from 15 MPa to 6 MPa for a given displacement of 0.4 mm. Based on the displacement analysis for the reference concrete block with uniform Young's modulus, the web section experienced the largest deformation as compared to the other sections, as shown in FIG. 7C. In various embodiments, mechanical failure of CMUs occurs when the web section cracks. In analogous to traditional cement-based blocks, therefore, the web section which experiences the lowest CO₂ uptake dictates the overall mechanical response in carbonated concrete blocks. In agreement with the FEM simulations, the measured compressive strengths of the concrete blocks were affected by gas flow distribution and correlated with overall CO₂ uptake, as shown in FIG. 7D. In various embodiments, the failure mode of concrete blocks varied from conical failure for top flow to conical/shear failure for longitudinal and transverse flow configurations in accordance with failure modes described in ASTM C1314. In various embodiments, more cracking may occur in the less-carbonated sections (e.g., web) of the blocks. This is thought to result from variations in material strength/stiffness properties that strongly dictate the failure mode by inducing shear/tension cracks along with the weakest zones. Therefore, the reduced compressive strength of less-carbonated blocks is linked to the combined effects of non-uniformity of material elastic properties and the reduced carbonation strengthening contribution.

The CFD modeling carried out herein allows analysis of the spatial distribution and velocity of contacting gas to inform the optimal: (a) design of gas flow distribution systems and (b) geometrical arrangement of concrete composites within a CO₂ mineralization reactor's volume so as to maximize and ensure the uniformity of CO₂ uptake of concrete composites. In various embodiments, variations in the contacting gas velocity affect drying, drying gradients, and consequently CO₂ uptake gradients within a monolith's volume. In various embodiments, other geometries of concrete composites may be formed which feature varying thicknesses and surface-to-volume ratios, i.e., to expand the palette of products that can be produced via CO₂ mineralization processes. In addition, the CFD simulations carried out herein form the basis for the development of a fully coupled heat-mass-chemical reaction-transport model that is may comprehensively relate aspects of binder composition, gas processing conditions (e.g., T, RH, [CO₂], and Q), reactor geometry, composite geometry, and CO₂ (mineralization) uptake to each other so as to maximize direct CO₂ utilization using industrial flue gas emission streams, in a time-, cost- and energy-efficient manner.

In various embodiments, gas flow distributions within the batch reactor affect CO₂ uptake and the resulting carbonate cementation of monolithic concrete composites (i.e., herein concrete masonry units: CMUs, also known as the concrete block). In various embodiments, drying kinetics and liquid water distributions resulting from varying gas flow distributions impact the rate and extent of carbonation. In various embodiments, the dependence of carbonation kinetics on the contacting gas velocity is attributed to the variation in drying kinetics and the penetration rate of drying front (i.e., S_{w} gradients) which affect the microstructural resistance to gas diffusion. Such S_{w} gradients result in non-uniform CO₂ uptake across the monolith volume, which imposes gradients in material properties (e.g., porosity and stiffness), and thereby impacts the overall mechanical response of carbonate-cemented concrete composites. In various embodiments, CFD and/or FEM simulations are used to assess the effects of the spatial distribution of contacting gas velocity across a concrete block surfaces on variations in CO₂ uptake within concrete block's sections and resultant material properties (stiffness and strength). In various embodiments, the effects of gas processing conditions (RH, T, and Q) on CO₂ mineralization reactions of the concrete block can be adjusted for determining the optimal gas flow configuration (e.g., selection of gas processing routes to enhance and to ensure uniformity of CO₂ uptake and material properties evolution within concrete composites). The outcomes are of relevance to design optimal carbonation systems, and to manufacture low-CO₂ concrete composites that utilize waste CO₂ borne in flue gas streams and fulfill relevant construction standards, without a need for a carbon capture step, and at ambient pressure.

The bulk oxide composition of the fly ash and ordinary portland cement (OPC) is presented in Table 1. The median particle size diameters (d₅₀) of the portlandite, fly ash, and OPC were determined as 3.8 μm, 8.9 μm, and 17.2 μm, respectively, using static light scattering. Densities were measured as 2340 kg/m³, 2440 kg/m³, and 3140 kg/m³, respectively, using helium pycnometry.

TABLE 1
Oxide composition of binders

| | Mass (%) | |
|---|---|---|
| Oxide | Fly Ash | OPC |
| SiO₂ | 51.60 | 20.60 |
| Al₂O₃ | 21.65 | 4.64 |
| Fe₂O₃ | 16.81 | 2.80 |
| SO₃ | 0.50 | 2.93 |
| CaO | 2.18 | 64.28 |
| Na₂O | 0.82 | 0.18 |
| MgO | 0.78 | 2.03 |
| K₂O | 2.29 | 0.32 |

Table 2 includes data from a factorial Design-of-Experiments (DoE) used to assess the effects of gas processing parameters (i.e., T, RH, and Q) on the carbonation of concrete blocks. Factorial DoE consists of three different parts: (i) factorial part (2ⁿ, n: number of design variables), (ii) central part, and (iii) validation part within the design space. The significance of variables and their interactions are determined by an analysis of variance (ANOVA) using the least-squares fitting. In this assessment, the probability (P-values) less than 0.05 was considered as a level of significance. For this series of experiments, the concrete blocks were first dried under exposure to flowing air to achieve different initial S_{w} prior to the carbonation process.

TABLE 2
Factorial Design-of-Experiments

| | | | | | Absolute Value | | |
|---|---|---|---|---|---|---|---|
| | Mixture | Coded Value | | | T | RH | Q |
| Type | ID | T | RH | Q | (° C.) | (%) | (splm) |
| Factorial | 1 | −1.0 | −1.0 | −1.0 | 20 | 20 | 0.10 |
| points | 2 | −1.0 | −1.0 | 1.0 | 20 | 20 | 4.92 |
| | 3 | −1.0 | 1.0 | −1.0 | 20 | 60 | 0.10 |
| | 4 | 1.0 | −1.0 | −1.0 | 50 | 20 | 0.10 |
| | 5 | −1.0 | 1.0 | 1.0 | 20 | 60 | 4.92 |
| | 6 | 1.0 | −1.0 | 1.0 | 50 | 20 | 4.92 |
| | 7 | 1.0 | 1.0 | −1.0 | 50 | 60 | 0.10 |
| | 8 | 1.0 | 1.0 | 1.0 | 50 | 60 | 4.92 |
| Central | 9 | 0.0 | 0.0 | 0.0 | 35 | 40 | 2.51 |
| points for 3 | | | | | | | |
| replicates | | | | | | | |
| Validation | 10 | 0.33 | 0.50 | −0.21 | 40 | 50 | 2.0 |
| points | 11 | 1.0 | −1.0 | −0.50 | 50 | 20 | 1.30 |
| | 12 | 0.0 | −1.0 | 0.20 | 35 | 20 | 3.0 |
| | 13 | 1.0 | 0.0 | 0.41 | 50 | 40 | 3 . . . 50 |

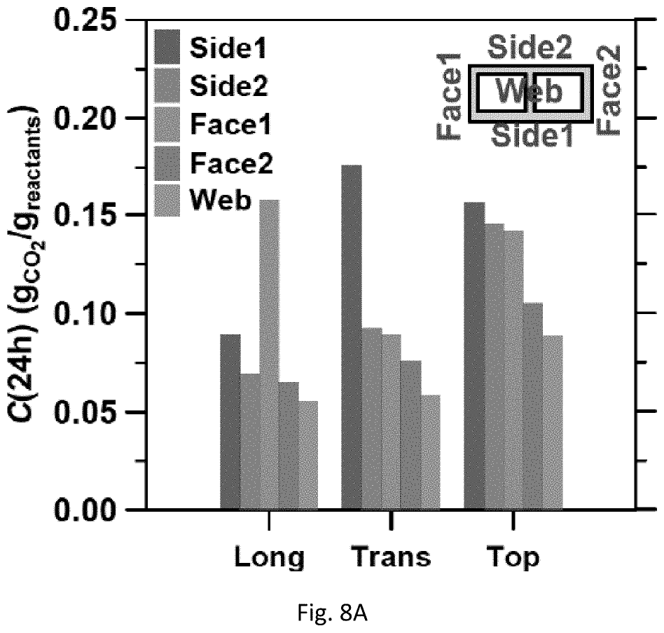

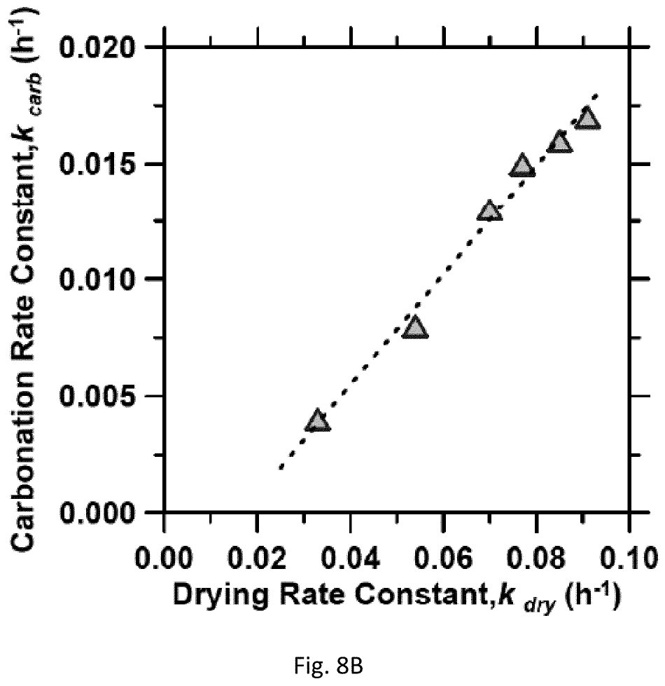

FIG. 8A illustrates a graph of the variations in the 24-h CO₂ uptake of different sections of the concrete block under different gas flow configurations. FIG. 8B illustrates a graph of the dependence of carbonation rate constant on drying rate constant. As shown in FIG. 8A, top flow provided the most uniform carbonation. FIG. 8B shows a strong dependence of carbonation rate constant on drying rate constant. In all carbonation experiments, the gas stream was [CO₂]=12.5% at T=70° C., RH=50%, and 2.45 slpm flow rate. In drying experiments, the air stream was [CO₂]=0.04% T=70° C., RH=50% and 2.45 slpm flow rate.

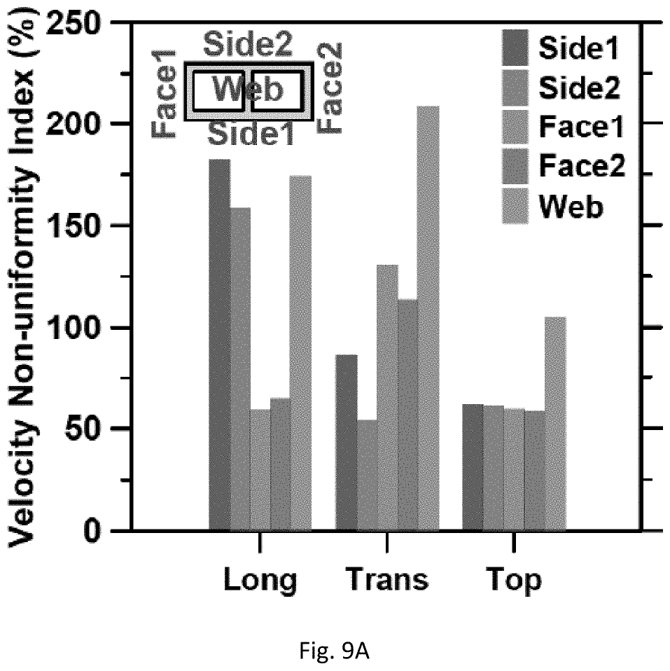

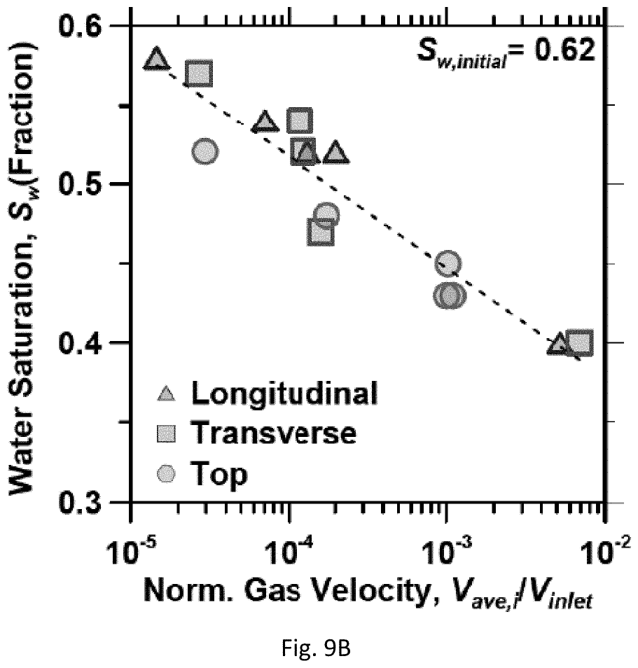

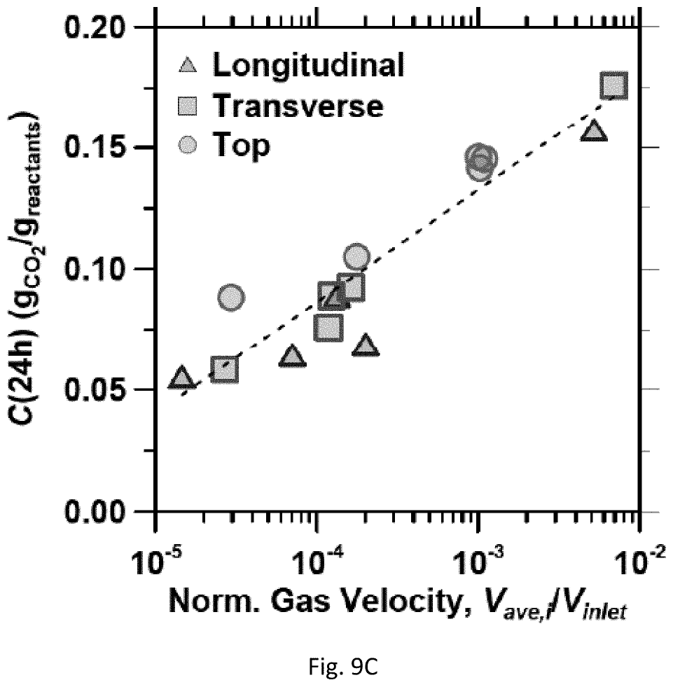

FIG. 9A illustrates a graph of the CFD analysis of velocity non-uniformity index across different surfaces of the concrete block for varying gas flow configurations. FIG. 9B illustrates a graph of the variations of pore water saturation (S_{w}) across different concrete block sections as a function of contacting gas velocity. The concrete block included S_{w, initial}=0.62 prior to the onset of the carbonation process. As shown in FIG. 9B, increasing contacting gas velocity resulted in a higher reduction of pore water saturation S_{w}. FIG. 9C illustrates a graph of the effect of contacting gas velocity across surfaces of concrete block on 24-h CO₂ uptake. In particular, FIG. 9C shows the effect of contacting gas velocity on C2 uptake for different sections of concrete block.

Table 3 includes data from the ANOVA results and derived statistical prediction models for pore water saturation S_{w} and CO₂ uptake.

TABLE 3
Analysis of variance (ANOVA) results of factorial design used
for carbonation performance evaluation of concrete block

| | | | | Contribution | | |
|---|---|---|---|---|---|---|
| | | F | p-value | (Actual | | |
| Response | Parameter | value | Prob > F | Factor) | R² | R²_{adj} |
| S_{w, drying} | Model | 13.20 | 0.0072 | | 0.92 | 0.85 |
| (after drying | Constant | | | 0.62890 | | |
| and prior to | T | 9.18 | 0.0291 | −0.00397 | | |
| carbonation) | RH | 23.62 | 0.0046 | 0.00198 | | |
| | Q | 12.54 | 0.0165 | −0.07348 | | |
| | T*RH | | NS | | | |
| | T*Q | | NS | | | |
| | RH*Q | 7.46 | 0.0412 | 0.00111 | | |
| | Curvature | 1.97 | 0.2195 | | | |
| C(24 h) | Model | 16.48 | 0.0044 | | 0.93 | 0.87 |
| | Constant | | | −0.00592 | | |
| | T | 5.23 | 0.0709 | 0.00127 | | |
| | RH | 19.38 | 0.0070 | −0.00022 | | |
| | Q | 27.48 | 0.0033 | 0.04373 | | |
| | T*RH | | NS | | | |
| | T*Q | | NS | | | |
| | RH*Q | 13.85 | 0.0137 | −0.00064 | | |
| | Curvature | 7.95 | 0.0371 | | | |

Notes:
T: gas temperature. RH: gas relative humidity. Q: gas flow rate. NS: not significant. Values of “Prob > F” less than 0.05 indicate that model terms are significant. The “Prob > F” determines if the curvature of response is significant as measured by the difference between the average of the central points and the average of the factorial points in the design space.

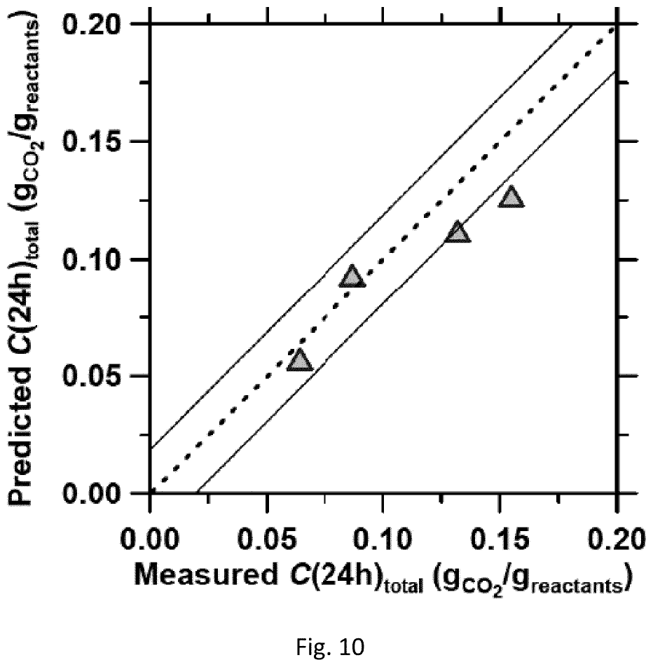

FIG. 10 illustrates a graph of a comparison between measured and predicted 24-h CO₂ uptake response. Four additional gas processing conditions were randomly selected within the design domain (see Table 2) to validate the accuracy of the derived statistical models. As shown in FIG. 10, the two diagonal solid lines represent 95% confidence interval bounds. FIG. 10 compares the accuracy of the derived statistical prediction model for the 24-h CO₂ uptake response for four additional gas processing conditions within the design space. As shown in FIG. 10, the predicted data points lie close to the 1:1 diagonal line, thus confirming the validity of the prediction model.

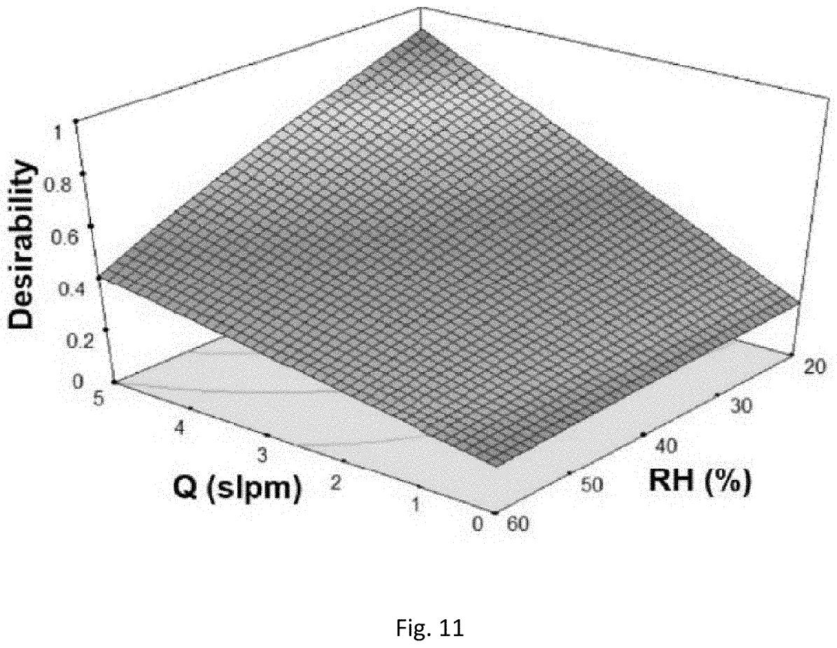

FIG. 11 illustrates a desirability surface response of gas processing conditions to satisfy defined performance targets. A desirability value close to 1 determines the optimal combination of variables that satisfies the target properties. In particular, FIG. 11 illustrates an example of the desirability response surface of gas processing conditions to meet specific performance targets. The targets were defined as maximizing the overall CO₂ uptake and minimizing the non-uniformity of CO₂ uptake across different block's sections. Increasing gas flow rate and decreasing gas RH results in enhanced desirability response so long as the pore water saturation of concrete block exceeds the critical value; S_{w}>S_{w,c}˜0.10.

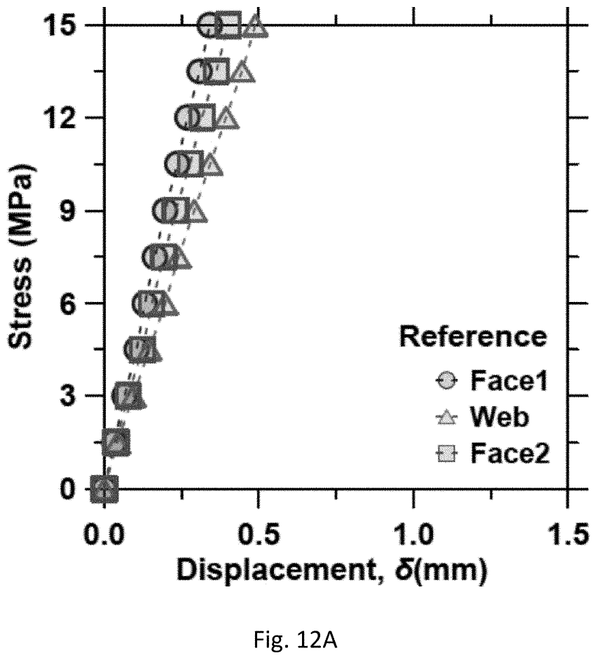

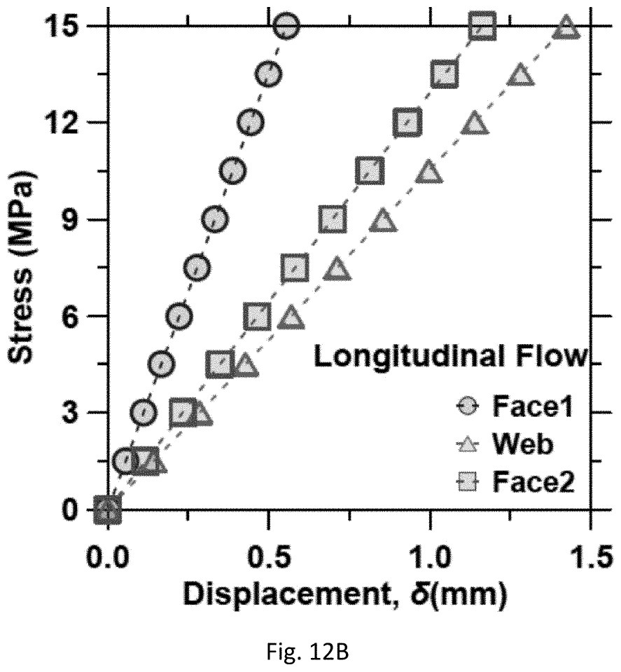

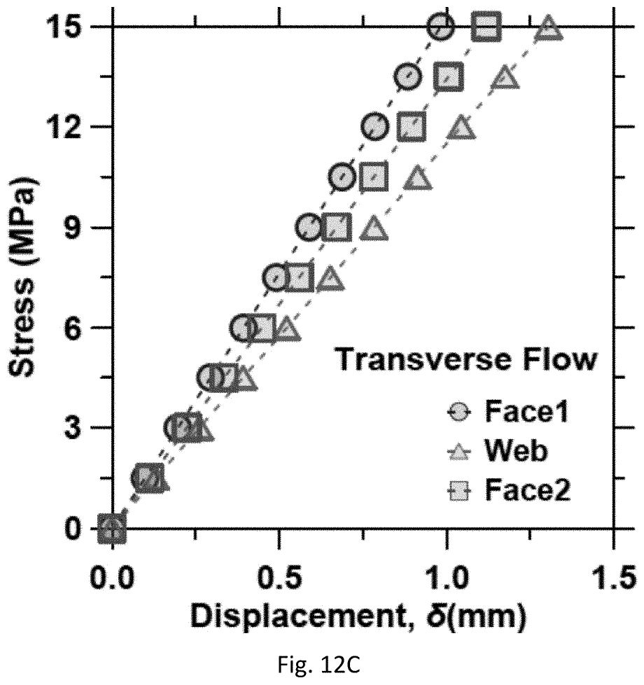

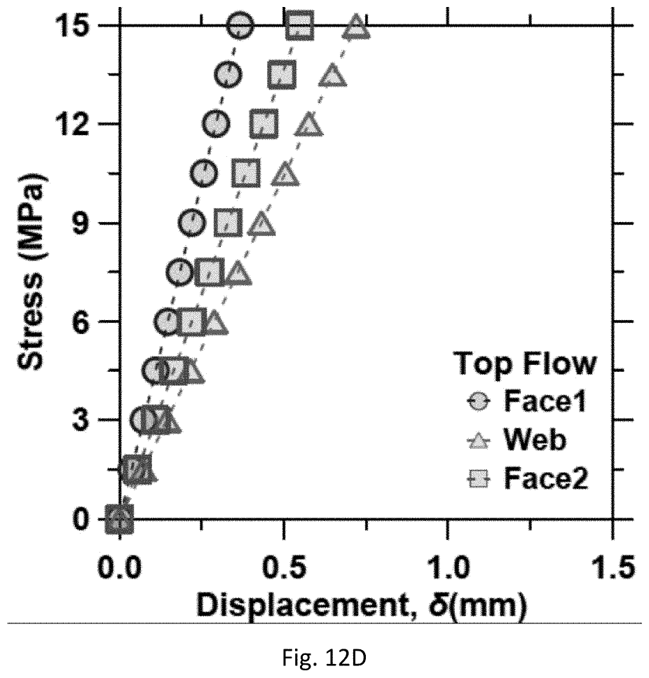

FIGS. 12A-12D illustrate graphs of FEM simulations of uniaxial compressive stress-displacement responses for different sections of: reference block (FIG. 12A), and for longitudinal flow (FIG. 12B), transverse flow (FIG. 12C), and top flow (FIG. 12D) configurations. The reference concrete block was modeled using an equivalent Young's modulus of 14 GPa for all block sections.

1. A method of manufacturing a carbonated concrete composite, the method comprising:
placing a concrete precursor into a carbonation reactor for carbonation curing, the concrete precursor comprising a binder, one or more aggregates, and water, and the carbonation reactor having at least one gas stream inlet and an outlet;
receiving a gas stream at the at least one inlet of the carbonation reactor, the gas stream comprising carbon dioxide;
maintaining a suitable temperature, relative humidity, CO₂ amount, gas stream flow rate, or a combination thereof in the carbonation reactor so a carbonation rate constant of the concrete precursor is at or above 0.005 to thereby react the concrete precursor with the gas stream and form the carbonated concrete composite.

2. The method of claim 1, wherein maintaining the suitable temperature, relative humidity, CO₂ amount, gas stream flow rate, or a combination thereof, in the carbonation reactor produces a carbonated concrete composite having uniform material performance.

3. The method of claim 1, comprising maintaining a temperature, relative humidity, CO₂ amount, gas stream flow rate, or a combination thereof, in the carbonation reactor which produces a carbonated concrete composite without a material performance gradient throughout the carbonated concrete composite.

4. The method of claim 1, comprising maintaining a temperature, relative humidity, CO₂ amount, gas stream flow rate, or a combination thereof, in the carbonation reactor which minimizes a material performance gradient in the carbonated concrete composite.

5. The method of claim 3, wherein the material performance is a measure of the carbonated concrete blocks porosity and/or or compressibility, and wherein the gradient is spatial difference in porosity and/or compressibility in the carbonated concrete block.

6. The method of claim 1, wherein the at least one inlet distributes gas directionally across the concrete precursor.

7. The method of claim 1, wherein the binder comprises portlandite.

8. The method of claim 1, wherein the carbonation reactor is a batch reactor.

9. The method of claim 1, wherein the carbonation reactor is a plug flow reactor.

10. The method of claim 1, wherein the carbonation reactor distributes gas uniformly across the concrete precursor.

11. The method of claim 1, wherein the carbonation reactor distributes gas across the concrete precursor to maximize contact of the concrete precursor with CO₂.

12. The method of claim 1, wherein the binder comprises hydrated lime.

13. The method of claim 1, wherein the binder comprises at least one of: ordinary portland cement and industrial solid waste.

14. The method of claim 13, wherein the industrial solid waste comprises fly ash.

15. The method of claim 1, wherein the one or more aggregates comprise at least one of: sand, gravel, and crushed stone.

16. The method of claim 1, wherein the concrete precursor comprises about 5 to about 50 mass % binder.

17. The method of claim 1, wherein the concrete precursor comprises about 2 to about 20 mass % water.

18. The method of claim 1, wherein the concrete precursor comprises about 50 to about 90 mass % one or more aggregates.

19. The method of claim 1, wherein the gas source is an effluent from an industrial source, a commercially-available CO₂ source, or liquefied CO₂.

20. The method of claim 1, wherein the gas stream comprises about 4% to about 99% carbon dioxide.

21. The method of claim 1, wherein the gas stream is provided to the inlet of the carbonation reactor at a flow rate of about 0.1 standard liters per minute (slpm) to about 5 slpm.

22. The method of claim 1, further comprising humidifying the gas stream prior to receiving the gas stream at the carbonation reactor.

23. The method of claim 22, wherein the gas stream is humidified to a relative humidity of about 10% to about 90%.

24. The method of claim 22, further comprising heating the gas stream while humidifying the gas stream.

25. The method of claim 24, wherein the gas stream is heated to a temperature of about 20° C. to about 80° C.

26. The method of claim 1, wherein the gas stream comprises a flue gas stream.

27. The method of claim 1, wherein the carbonation reactor has a top flow configuration.

28. The method of claim 1, wherein the carbonation reactor has a transverse flow configuration.

29. The method of claim 1, wherein the carbonation reactor has a longitudinal flow configuration.

30. The method of claim 1, wherein the carbonized concrete composite is a concrete block.

31. The method of claim 30, wherein the concrete block has a length of about 25 mm to about 1000 mm, a height of about 25 mm to about 500 mm, and a width of about 25 mm to about 1000 mm.

32. The method of claim 1, wherein the concrete composite has a compressive strength of about 8 to about 50 MPa.

33. The method of claim 1, wherein the concrete composite has a porosity of about 0.1% to about 20%.

34. A carbonated concrete composite made by the method of claim 1.

35. A CO₂ mineralization system comprising:
a gas humidification chamber;
a gas stream coupled to an input of the humidifier, wherein the gas stream comprises carbon dioxide; and
a gas inlet coupled to a carbonation reactor and an output of the humidification chamber;
wherein:
the carbonation reactor is configured to receive concrete and react the concrete with the gas stream to thereby form a carbonated concrete composite.

36-42. (canceled)

43. A method of manufacturing a first carbonated concrete composite and a second carbonated concrete composite, the method comprising:
placing a first concrete masonry unit (CMU) precursor into a carbonation reactor for carbonation curing, the first CMU precursor comprising a binder, aggregates, and water, and the carbonation reactor having at least one gas stream inlet and an outlet;
exposing the first CMU precursor to a gas stream from the at least one gas stream inlet of the carbonation reactor, wherein the gas stream comprising carbon dioxide;
maintaining a temperature, relative humidity, CO₂ amount, gas stream flow rate, or a combination thereof in the carbonation reactor so that a carbonation rate constant of the first CMU precursor is at or above 0.005 to thereby react the first CMU precursor with the gas stream and form the first carbonated concrete composite;
measuring the compressibility and/or porosity of the first carbonated concrete composite;
placing a second CMU precursor into the carbonation reactor for carbonation curing, the second CMU precursor comprising a binder, aggregates, and water;
exposing the second CMU precursor to a modified gas stream from the at least one inlet of the carbonation reactor; and
maintaining a temperature, relative humidity, CO₂ amount, gas stream flow rate, or a combination thereof in the carbonation reactor so a carbonation rate constant of the second CMU precursor is at or above 0.005 to thereby react the second CMU precursor with the gas stream and form a second carbonated concrete composite.

44-47. (canceled)
